(19) United States
(12) Patent Application Publication
(10) Pub. No.: US 2011/0029445 A1
(43) Pub. Date: Feb. 3, 2011

(54) PHARMACEUTICAL PRODUCTION MANAGEMENT SYSTEM

(75) Inventors: Bretten Whittacre, Henderson, NV (US); Dennis Eshima, Tempe, AZ (US); Arris Robinson, Phoenix, AZ (US); Troy Connelly, Henderson, NV (US)

Correspondence Address: PILLSBURY WINTHROP SHAW PITTMAN LLP, P.O BOX 10500, McLean, VA, 22102, US

(73) Assignee: BIODOSE, LLC, Las Vegas, NY (US)

(21) Appl. No.: 12/848,031

(22) Filed: Jul. 30, 2010

Related U.S. Application Data
(60) Provisional application No. 61/230,660, filed on Jul. 31, 2009.

(51) Int. Cl. G06Q 50/00

(52) U.S. Cl. 705/317

(57) ABSTRACT

A computer includes a memory and a processor, the memory having instrul. A computer-implemented method, a computer comprising a storage device, a memory and a processor, the storage device having instructions stored therein. The instructions, which when executed by the processor, causes the computer to (1) receive, at the production module, a request for production of a radioactive pharmaceutical; (2) verify, utilizing a training module on the computer, completion by the user of at least a training program corresponding to production of the radioactive pharmaceutical; (3) verify completion by the user of equipment calibration requirements and equipment qualification requirements for the equipment that is used in the production of the radioactive pharmaceutical; and (4) prevent access to further operations of the production module if the training program has not been completed, the equipment calibration requirements have not been completed or the equipment qualification requirements have not been completed.

### CROSS-REFERENCE TO RELATED APPLICATIONS

0001. This application claims priority to provisional application Ser. No. 61/230,660 filed on. Jul. 31, 2009.

### BACKGROUND OF THE INVENTION

Medical imaging is used extensively to diagnose and treat patients utilizing modalities such as Magnetic Resonance Imaging (MRI), Computed Tomography (CT), Positron Emission Tomography (PET), and Single Photon Emission. Computed Tomography (SPECT). These modalities provide complementary diagnostic information. PET and SPECT scans illustrate functional aspects of the organ or region being examined and allow metabolic measurements, but delineate the body structure relatively poorly. In contrast, CT and MRI images provide excellent structural information about the body, but provide little functional information.

PET and SPECT are classified as “nuclear medicine” because they measure the emission of a radioactive material which has been injected into a patient. After the radioactive material, e.g., a radiopharmaceutical, is injected, it is absorbed by the blood or a particular organ of interest. The patient is then moved into the PET or SPECT detector which measures the emission of the radiopharmaceutical and creates an image from the characteristics of the detected emission.

Proper manufacturing and administration of pharmaceuticals involving radiation (e.g., contrast media, radiopharmaceuticals) is dependent on human reliability to insure the correct drug is maintained and administered properly. The consequences of mistakes in either the manufacturing, transportation, or administration of radiopharmaceuticals (or contrast media) can be severe. However, with millions of injections of radiopharmaceuticals per year, plus the increasing affordability of their use driving the number of uses higher, there is a continuing effort to further reduce mistakes in the manufacturing, distribution and administration of these radiopharmaceuticals. A great majority of the mistakes in the manufacturing, distribution and administration of these pharmaceuticals are the result of human error.

Examples of radiopharmaceuticals include ¹⁸FDG, MDP, DTPA and ⁹⁹Tc-RBCs. The half lives of these radiopharmaceuticals may range from two minutes to two hours. Thus, the administration of the radiopharmaceutical to the patient and the imaging utilizing the radiopharmaceuticals must take place within a very short time period after the radiopharmaceutical and properly dosed for the patient. Many hospitals do not facilities to manufacture radiopharmaceuticals and must order them from a radiopharmaceutical pharmacy. The ordered radiopharmaceutical is then delivered by ground or air transport from nearby manufacturing facilities.

Facilities for manufacturing radiopharmaceuticals must meet certain requirements, such as the structure required to support a massive cyclotron (which is the first step in manufacturing some of radiopharmaceutical or radioactive pharmaceuticals). Further, the air circulation system for the facility must be high grade and there are stringent shielding requirements arising from the radioactive nature of the radiopharmaceutical. Illustratively, the cyclotron may be housed in its own self shielding housing which includes lead or other shielding for protecting users from exposure to radiation such as gamma rays and neutrons.

In addition, during the manufacturing of the radiopharmaceutical, specific procedures (which are referred to as Standard Operating Procedures (SOPs) are put in place in order to meet all of the regulatory requirements. The SOPs have to be written down and conform with governmental regulations.

In many applications, the radioisotope produced by the cyclotron is subjected to further processing before being shipped to a hospital and then administered to a patient. For example, ¹⁸FDG is a radiopharmaceutical is administered to patients undergoing PET imaging. The cyclotron produces a radioisotope and this is provided to a synthesis unit. The radioisotope produced by the cyclotron is transferred, e.g., automatically, to a reservoir on the synthesis unit. The synthesis process may be controlled by a computer and displayed graphically on a screen along with relevant conditions and values. The components of the synthesis unit, e.g., valves, heaters, coolers, etc., may be controlled automatically or manually. Automated synthesis units are also commercially available. Synthesis units are available for commercially for producing other radiopharmaceuticals.

Illustratively, a synthesis unit may include a separation cartridge, a target water vial, a vial, a reactor, an FDG collection vessel, an FDG purification column, a reactor needle, and a reagent vial. A synthesis unit may include supporting apparatuses, including an electronics unit, a computer, a printer, a dewar, a vacuum pump, a transformer, and inert gas and compressed air regulators. The collection vessel of the synthesis unit collects the radiopharmaceutical produced by the synthesis unit. The radiopharmaceutical solution can then be dispensed into a sterile vial, which may be sealed with a septum and cap.

The radiopharmaceutical production or manufacturing facility may also include quality control equipment to measure the quality of the products produced or manufactured in the facility. For example, GM-tubes may be provided to monitor the radioactivity amounts of the target water of the cyclotron, the reactor vessel of the synthesis unit, and the radiopharmaceutical collecting vial. High performance liquid chromatography equipment with a radioactive detector (Radio-HPLC) or radio-thin layer chromatography equipment (Radio-TLC) may be used to measure the radiochemistry purity of a radiopharmaceutical. High performance liquid chromatography (HPLC) equipment and gas chromatography (GC) equipment may be provided to analyze the chemical purity of the radiopharmaceutical products.

The radiophamiaceutical produced by the synthesis unit may be further processed for specific applications, (dispensed into individual vials), for example, in a clean room. Robotic systems may be used to dispense the radiopharmaceutical into individual vials. Or an employee may dispense the radiopharmaceutical into individual vials, sometimes in radioactive hoods. The manufacturing facility may also include other equipment useful for producing radiopharmaceuticals. For example, the manufacturing facility typically includes a “hot cell” which provides a radioactive shield and a vented environment for one or more synthesis units and/or dispensing robots. A TLC scanner may be provided to determine the radio-chemical purity of the final radiopharmaceutical. A multichannel analyzer may be provided to determine the energy level of gamma rays, which allows a user to validate that only a PET isotope was generated by the cyclotron. A dose calibrator, which is typically an FDA licensed device, may be provided to determine the quantity of radioactivity in the dose being dispensed. Radiopharmaceuticals may be checked with a dose calibrator before being dispensed to the patient. An incubator may be provided to validate the sterility of the final product and to perform microbial testing of the manufacturing environment and air systems. An oven may be provided to depyrogenate glassware and other items used in the production of the radiopharmaceutical.

The vials are then placed into a shielded container, e.g., constructed of lead or tungsten, which is transported to the desired location. The shipping container may be tested for both surface radiation and activity measured at a specified distance, e.g., one meter. State and federal regulations on pharmaceuticals and shipping typically require specific documentation of pharmaceutical shipments.

To facilitate proper handling and disposal of the radioactive materials, the manufacturing facility may also include a Biotrax™ system which monitors each of the chemicals within a radiopharmaceutical manufacturing facility. Further, many manufacturing facilities may also include a separate pharmacy software program for monitoring the ordering, dispensing and shipping of radiopharmaceuticals.

A complete radiation monitoring system can assure production workers of an acceptable level of background radiation in all areas of the facility. Additional monitoring of all gases and air exhaust systems can be maintained providing a continuous recording of all radioactivity that is released into the environment.

Because there are so many regulations and procedures to follow, it is imperative that equipment be properly maintained, that the operators are properly trained on the equipment, the facility is properly maintained and that radiation safety procedures are followed. Thus, there is a need for a system that ensures that all procedures are followed. If proper procedures are not followed, then there is a need for a system that prevents manufacturing or production of the radiopharmaceuticals.

### BRIEF DESCRIPTION OF THE DRAWINGS

FIG. 1 illustrates a computer system for controlling the manufacturing and producing radiopharmaceuticals according to an embodiment of the invention;

FIG. 2 illustrates a block diagram of the radiophannaceutical production management system according to an embodiment of the invention;

FIG. 3 illustrates the production module flow chart according to an embodiment of the invention;

FIG. 4 is a flowchart illustrating creation or adding of a SOP to the document repository accordingly to an embodiment of the invention;

FIG. 5a illustrates a flowchart of an SOP check-out module according to an embodiment of the invention;

FIG. 5b illustrates a flowchart of an SOP check-in module according to an embodiment of the invention;

FIG. 5c illustrates a flowchart of the SOP Adjustment module according to an embodiment of the invention;

FIG. 5d illustrates a flowchart for revision changing according to an embodiment of the invention;

FIG. 6a illustrates a flowchart of operation of a Diff Module according to an embodiment of the invention;

FIG. 6b illustrates a flowchart for deleting documents according to an embodiment of the invention;

FIG. 7 illustrates operation of an equipment add module according to an embodiment of the invention;

FIG. 8a illustrates an equipment edit module according to an embodiment of the invention;

FIG. 8b illustrates an equipment delete module according to an embodiment of the invention;

FIG. 9 illustrates an equipment completion module according to an embodiment of the invention;

FIG. 10(a) illustrates operation of a facility add module according to an embodiment of the invention;

FIG. 10(b) illustrates a facility edit module according to an embodiment of the invention;

FIG. 11(a) illustrates operation of a facility delete module according to an embodiment of the invention;

FIG. 11(b) illustrates the operation of the facility task completion module according to an embodiment of the invention;

FIG. 12(a) illustrates operation of a training add module according to an embodiment of the invention;

FIG. 12(b) illustrates operation of a training edit module according to an embodiment of the invention;

FIG. 13(a) illustrates operation of a training delete module according to an embodiment of the invention;

FIG. 13(b) illustrates operation of a training completion module according to an embodiment of the invention;

FIG. 14(a) illustrates operation of a user add module according to an embodiment of the invention;

FIG. 14(b) illustrates operation of a user delete module according to an embodiment of the invention;

FIG. 14(b1) illustrates operation of a user edit module according to an embodiment of the invention;

FIG. 14(c) illustrates operation of the user group add module according to an embodiment of the invention;

FIG. 14(c1) illustrates operation of the user group delete module according to an embodiment of the invention;

FIG. 14(d) illustrates operation of a user group edit module according to an embodiment of the invention;

FIG. 15 illustrates operation of a user group assignment module according to an embodiment of the invention;

FIG. 16 illustrates operation of the document permission module according to an embodiment of the invention;

FIG. 17 illustrates operation of the document sign-off module according to an embodiment of the invention;

FIG. 18 illustrates operation of the document signature setup module according to an embodiment of the invention; and

FIG. 19 illustrates operations of the search module according to an embodiment of the invention.

### DETAILED DESCRIPTION OF THE INVENTION

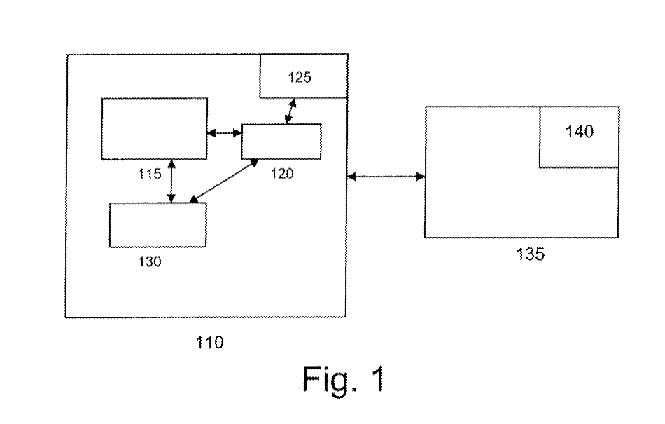

FIG. 1 illustrates a computer system for controlling the manufacturing and producing radiopharmaceuticals according to an embodiment of the invention. In an embodiment of the invention, the radiopharmaceutical production management system has a client-server architecture. Alternatively, the radiopharmaceutical production management system may be installed a single computer. The radiopharmaceutical production management system may be installed on a server 110, where the server has a storage device 115, a processor (or multiple processors) 120, a display or monitor 125, and a memory 130. A client computer 135 may be coupled to the server 110 and the client computer may have a display 140.

The invention may be implemented in software. In another embodiment of the invention, some or all aspects of the invention may be implemented in hardware or software, or a combination of both (e.g., programmable logic arrays). Unless otherwise specified, the algorithms included as part of the invention are not inherently related to any particular computer or other apparatus. In particular, various general purpose machines may be used with programs written in accordance with the teachings herein, or it may be more convenient to construct more specialized apparatus (e.g., integrated circuits) to perform particular functions. Thus, the invention may be implemented in one or more computer programs executing on one or more programmable computer systems each comprising at least one processor, at least one data storage system (which may include volatile and non-volatile memory and/or storage elements), at least one input device or port, and at least one output device or port.

The invention may be implemented using the client-server model. Client software may be installed on multiple machines in a facility and the workstations may be coupled to a central or remote server. The application program or a significant portion of the program may reside on the server. A database may house relevant data for the application and a database engine may control access to the data.

Program code is applied to input data to perform the functions described herein and generate output information. The output information is applied to one or more output devices, in known fashion.

Each such program may be implemented in any desired computer language (including machine, assembly, or high level procedural, logical, or object oriented programming languages) to communicate with a computer system. In any case, the language may be a compiled or interpreted language.

Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein.

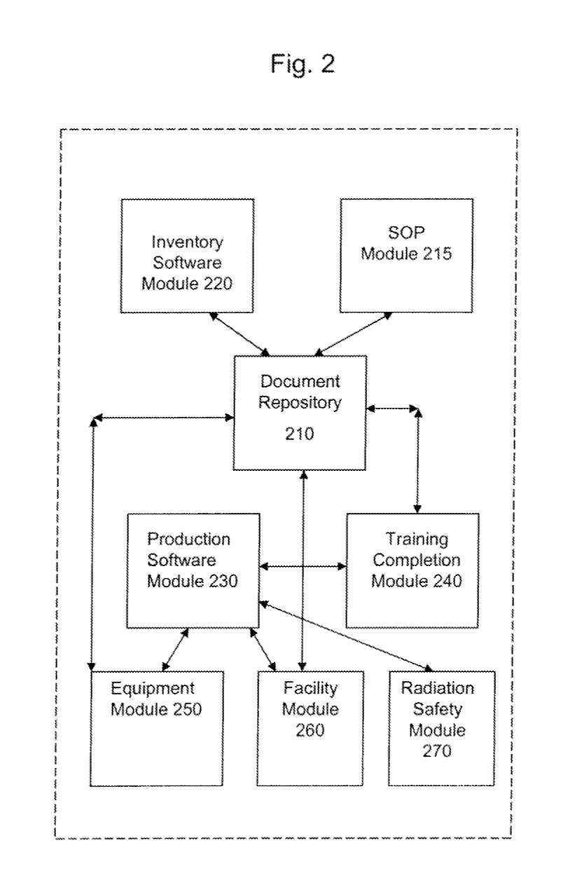

FIG. 2 illustrates a block diagram of the radiopharmaceutical production management system according to an embodiment of the invention. The radioactive pharmaceutical production management system includes a document repository 210, a standard operating procedure creation/editing module 215, an inventory software module 220, a production software module 230, a training completion software module 240, an equipment calibration module 250, a facility maintenance module 260 and a radiation safety module 270.

FIG. 1.2 illustrates a main menu for the radiopharmaceutical production management system. In FIG. 1.2, there is an icon 251 for the document repository, an icon 252 for the inventory subsystem, an icon 253 for the production module, an icon 254 for the training module, an icon 255 for the equipment module, an icon 256 for the facility module and an icon 257 for the radiation safety module.

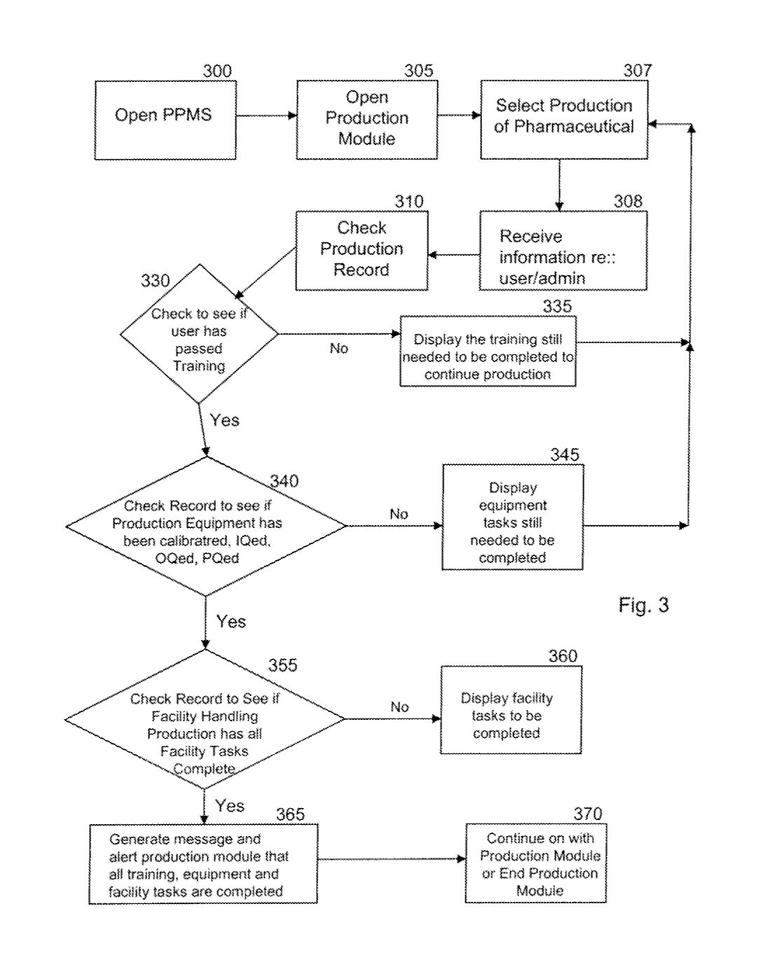

Production Module—FIG. 3 illustrates the production module flow chart according to an embodiment of the invention. The radiopharmaceutical production application may be opened or executing 300 and the radiopharmaceutical production management system may receive 305 input to open (or execute) the production module. The production module is utilized to track the production of the radiopharmaceutical, to verify all requirements are met as the radiophannaceutical is being produced and to keep track of measurements and other important data generated during the production of the radiopharmaceutical. The production module receives 307 input identifying that a new production of a pharmaceutical is to be completed. In order to start actual production of the radiopharmaceutical, the production module in the radiopharmaceutical production management system verifies that certain requirements have been met. If some or all of the radiopharmaceutical production requirements are not met, the production module does not allow a user to continue production of the radiopharmaceutical. Illustratively, no other modules of the radiopharmaceutical production management system may be entered by the user until the specified requirements have been met.

Illustratively, the production module verifies that individuals who are to be involved in producing the radiopharmaceutical have received the necessary training for the equipment that is to be utilized in the radiopharmaceutical production. Further, the production module verifies that the equipment has passed qualification requirements before allowing radiopharmaceutical production. In addition, the production module may verify that maintenance and other tasks has been performed within the facility that is producing the radiopharmaceutical. If the production module determines that one of the training requirements, equipment calibration or operation requirements or facility maintenance task have not been completed, the production module does not allow production of radiopharmaceutical.

Illustratively, a radiopharmaceutical production management system could include a production record for each radioactive pharmaceutical that a facility or group of facilities is capable of production. The production management system may also include a requirements list. For example, radiopharmaceutical A may have a corresponding production record identifying 1) the training requirements for producing radiopharmaceutical A, 2) the equipment requirements for producing radiopharmaceutical A and 3) the facility requirements for producing radiopharmaceutical A. As an illustrative example, to manufacture radioactive pharmaceutical A, you have to 1) complete training courses and training simulations 1, 2, and 3; 2) the following equipment (dose calibrator, cyclotron, robotic picker assembly) has to be calibrated and had IQ, OQ, and PQ requirements have to be met, and the 3) the facility has to have tasks a, b and c completed. Similarly, you could have a slightly different set of requirements for manufacturing radioactive pharmaceutical B.

In general operation, the production module performs the following operations when it is verifying that the training, equipment and facility requirements are met. The production module interacts with the training module to verify that the training record for the individual has the necessary items completed. For radioactive pharmaceutical A, for example, the individual's training record would need to have signed off as completed training exercises or simulations 1, 2 and 3.

The production module then interacts with the equipment module. The production module would check the equipment records for each of the pieces of equipment which are needed to manufacture the pharmaceutical. Illustratively, the production module interfaces with the equipment module and verifies that the calibration, IQ, OQ and PQ have been signed off for each of the dose calibrator, the cyclotron and the robotic picker. In other words, the production module is checking the dose calibrator equipment record, the cyclotron equipment record, and the robotic picker equipment record to verify sign off or completion.

The production module would then interact with the facility module. The production module interfaces with the facility module and investigate a facility record to identify that all necessary facility tasks have been signed off/complete.

Referring back to FIG. 3, the production module also receives 307 radiopharmaceutical input indicating the type of radiopharmaceutical that is to be produced or manufactured. For example, the production module may receive input identifying that FDG is to be produced. The radiopharmaceutical production management system may also receive 308 personnel input identifying which user is starting and managing the production of the radiopharmaceutical.

The production module may check 310 a production record for the type of radiopharmaceutical that is to be produced. The production record may identify the list of requirements that need to be performed or completed before production of a pharmaceutical may begin. For example, radiopharmaceutical FDG may have a production record that lists 1) the training requirements necessary before an individual can manage production of FDG; 2) the equipment needed to produce FDG; and 3) the facility task requirements necessary to be completed before production may begin. As an illustrative example, to manufacture radioactive pharmaceutical FDG, you have to 1) complete training courses for the dose calibrator and cyclotron and complete a training simulation of operating the cyclotron; 2) verify that the following equipment (dose calibrator, cyclotron, and a robotic picker assembly) each have been calibrated and had passed IQ, OQ, and PQ, and the 3) verify that the facility tasks of cleaning the floor, performing insect irradiation and cleaning the air exchange system have been performed. Thus, in this example, the production record for FDG may list nine items (i.e., complete training course on dose calibrator; complete training course on cyclotron; complete training operation simulation on the cyclotron; verify the dose calibrator is calibrated and meets qualification requirements; verify the cyclotron is calibrated and meets qualification requirements; verify the robotic picker assembly is calibrated and meets qualification requirements; verify that floor cleaning is completed; verify that insects have been irradiated, and verify that cleaning of the air exchange system has been performed).

In an embodiment of the invention, the radiopharmaceutical production module may access an individual's training record to determine the equipment that the user has been trained on. Illustratively, the production module reviews the employee training record to verify 330 that individual has been trained on the equipment that is to be utilized in production of the selected radioactive pharmaceutical. The production module may also verify that the individual has completed training exercises for the selected equipment. Illustratively, a cyclotron, a synthesis unit, a robotic dispensing unit and a dose calibrator may be utilized for production of one pharmaceutical. In this example, the production module checks the individual's training record to verify that the user has been trained on all of the equipment and has passed and completed corresponding training exercises for the identified equipment.

If the production module determines that the individual has not been trained on the selected equipment and/or has not been passed the operational tests associated to operate the equipment, the production module generates 335 a message. Illustratively, the message may be transmitted so that it is displayed on a computer screen/display associated with the pharmaceutical production management system. The message may include text that the individual needs to complete training. The message may also provide an indication of what training needs to be completed before the individual can complete production of the radiopharmaceutical. The message may also state that the individual needs to perform certain training simulation modules for the equipment before the individual can utilize the pharmaceutical production management system to produce the radiopharmaceutical. If the production module determines the training requirements have not been met, the production module reverts back to a production module main menu screen. If the individual has been trained on the equipment and has passed the corresponding training exercises for the equipment, the production module then verifies whether the equipment is ready for utilization in the production of the radioactive pharmaceutical.

The production module utilizes the list of equipment from the production record and verifies 340 that the identified equipment corresponding to the production of the radiopharmaceutical has been signed off as to ready for use. Each piece of equipment utilized in the production of the radiopharmaceutical or associated with production of the radiopharmaceutical includes equipment record. The equipment record includes: equipment identification information; equipment calibration information and whether the calibration has been signed off; installation qualification (IQ) information and whether the IQ has been signed off; operational qualification (OQ) information and whether it has been signed off; and production qualification (PQ) information and whether it has been signed off.

In addition, the equipment record may include information as to what tests need to be performed after the equipment has been repaired. Illustratively, the equipment may list that calibration of the equipment, OQ and PQ testing should be completed after a repair. Documents which describe some of these procedures (e.g., operational qualification procedure, installation qualification procedure, production qualification procedure, and calibration procedure) may be referred to as Standard Operating Procedures (SOPs) and are discussed below.

Illustratively, the production module determines if the selected equipment for radiopharmaceutical production has been calibrated by evaluating/checking the equipment record for each piece of the selected equipment. The production module may also determine if the equipment installation qualification has been performed and signed off by evaluating/checking the equipment record. Further, the production module, may determine if the equipment operational qualification has been performed and signed off by evaluating/checking the equipment record. In addition, the production module may determine if the equipment production qualification has been performed and signed off by evaluating/checking the equipment record. With equipment that needs to have certain procedures performed after repair, if the equipment has certain procedures that need to be completed after repair, the production module may determine if these procedures after repair have been performed by evaluating/checking the equipment record.

If the equipment has not been calibrated (or if the equipment has not had one of the qualifications performed and signed off (e.g., any of the Installation Qualification, the Operation Qualification, the Production Qualification), then the production module generates 345 a message to identify that equipment calibration or equipment qualification needs to be performed in order to continue with production of the radioactive pharmaceutical. The message may be displayed on a monitor associated with the radiopharmaceutical production management system.

If the equipment has not been calibrated or if the equipment has not had one of its qualifications performed and signed off, the production module may revert 350 back to the production module main menu. The production module is preventing the individual from continuing with production of the radiopharmaceutical utilizing the radiopharmaceutical production management system. In an embodiment of the invention, the production module may evaluate each piece of equipment individually and generate messages specifically for each piece of equipment. Further, the production module may generate very specific error messages identifying which qualification was not performed or signed off and providing links to the identified qualification SOP document. If all of the selected equipment has been calibrated and the qualifications performed and signed off, the production module then determines whether or not the facility at where the radiopharmaceutical is to be produced has had the proper maintenance performed.

The radiopharmaceutical production management system may include a facility record (for the facility utilized in the production of the radiopharmaceutical) or facility records (if multiple facilities are used during production of the selected radiopharmaceutical). The facility record may information as to whether maintenance has been performed at the facility. For example, maintenance procedures may include overall cleaning of the facility, insect cleaning at the facility, verifying that any shielding in the building still meets specifications, or cleaning and maintaining the air supply system for the facility. The production module may check/evaluate 355 the facility record to identify if all of the tasks or maintenance for the facility has been performed. If all of the tasks for the facility have not been performed, then the production module may generate 360 a message indicating that tasks or facility maintenance needs to be performed before the production of the radiopharmaceutical may proceed. The message may be displayed on a monitor associated with the radiopharmaceutical production management system. If the tasks or maintenance has not been performed, then the production module may revert 365 back to the main menu of the production module. If the facility maintenance and/or tasks have been completed, then the production module may continue with operation. An indicator may be set in the production module to identify that all prerequisites for actual production of the radiopharmaceutical had been completed. Then, the production module may continue 370 with management of the production of the radiopharmaceutical and actual production of the pharmaceutical.

SOP DISCUSSION—As identified previously, a standard operating procedures (SOP) must be followed to ensure radiopharmaceuticals are produced in a quality manner. All tasks, procedures, qualifications, tests or the like should be memorialized in a SOP. In a radiopharmaceutical production or manufacturing environment, SOPs are essential and should be drafted, agreed upon and instituted by all individuals working in a production facility. There is even an SOP on how to create or write an SOP. Illustratively, in a radiopharmaccutical production management system, SOPs are created for 1) the receiving, handling and storage of a chemical that is later used in producing the radiopharmaceutical; 2) the operation a piece of equipment that is utilized in the production of the radiopharmaceutical (e.g., the operation of the cyclotron); 3) the maintenance that needs to be performed at the production facility on a monthly basis; and 4) for the steps that occur in the synthesis of the radioisotope after the radiopharmaceutical is received from the cyclotron. An SOP module creates and edits SOPs in the radiopharmaceutical production management system.

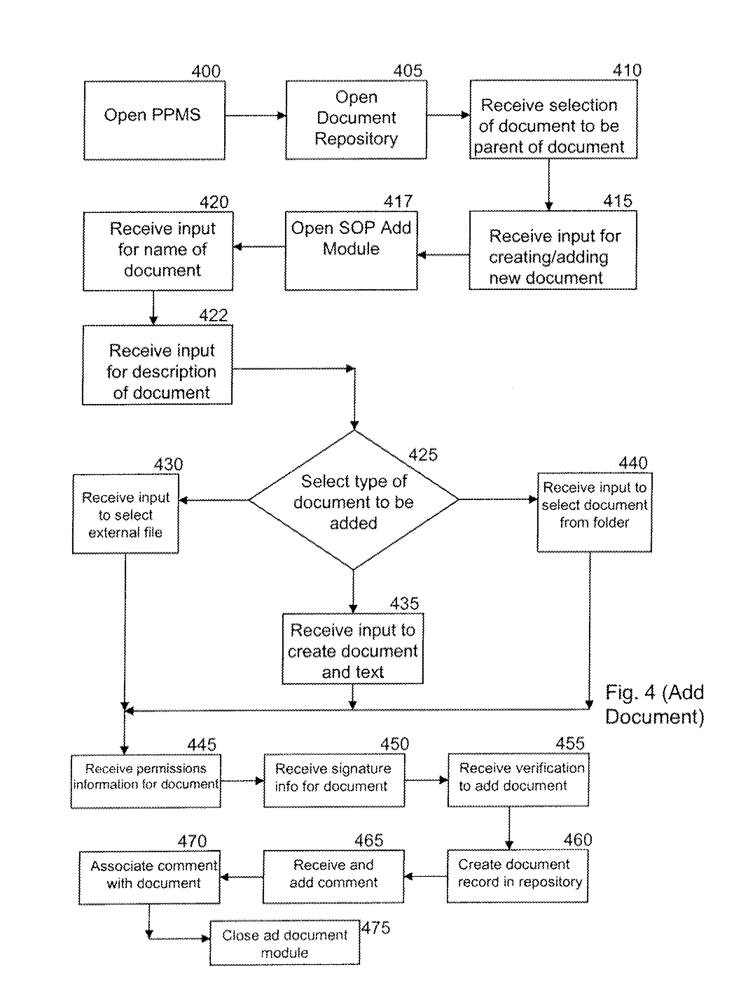

The SOP module is utilized to create, edit, delete, or upload SOPs into the document repository as well as identifying which categories the SOPs are classified. FIG. 4 is a flowchart illustrating creation or adding of a SOP to the document repository accordingly to an embodiment of the invention.

Before creating an SOP document, the SOP module opens 405 the document repository. Under certain operating conditions, the SOP module may receive 410 document parent information identifying that an existing document is a parent document to a new document about to be added to the document repository. The SOP module receives 415 new document information identifying that a new document is being added to the document repository. The SOP module opens 417 an SOP add module. Illustratively, a new document button may be selected on a SOP main menu and a SOP add menu may be displayed. The SOP add module receives 420 422 the name and description of the new document.

The new SOP may be created, added from a file on the pharmaceutical production management system or imported from an external system (e.g., installation instructions for an equipment item). The SOP add module receives 425 document type information (e.g., is a folder of documents to be added, is a new document to be created, is a file to be imported). If the new document is to be imported, the SOP add module may import 430 a new SOP document from an external source (e.g., an equipment manufacturer's calibration document, a chemical/pharmaceutical manufacturer's handling instructions for the chemical or pharmaceutical). If the new document is to be created, the SOP Add Module may create 435 a new document. Illustratively, the SOP Add Module may include a built-in text editor to type in text for the new SOP document. The text editor may save the created document. If the SOP document (or documents) is to be added from an existing folder on the radiopharmaceutical production management system, the SOP add module may receive 440 the selection of the document (or documents) from a folder existing in the radiopharmaceutical production management system.

The SOP add module receives 445 permission information for the new SOP document. The setup permissions may be established for the document(s) via a permissions module, which is described below. The document permission may include whether or not the document allows users to create document permissions, edit document permissions or view document permissions. Illustratively, document permissions may be view, edit or delete.

The SOP add module receives 450 signature requirements for the new document. The signature requirements for the new document may be received via a signature module, which is described below. After the SOP add module receives the permission information and signature requirements, the new document (or documents) may be added 455 to the document repository. For example, the new document may be added by selecting an “add document” button on an SOP add menu. Under certain operating conditions, comments may be received and associated with the new document. For example, an “add comment” dialog box may opened 460 and a comment may be entered 465 and then associated 470 with the new document. The “add comment” dialog box may then be closed. The comments may be saved along with the new SOP document in the document repository. The SOP add module may then be exited 475 and closed.

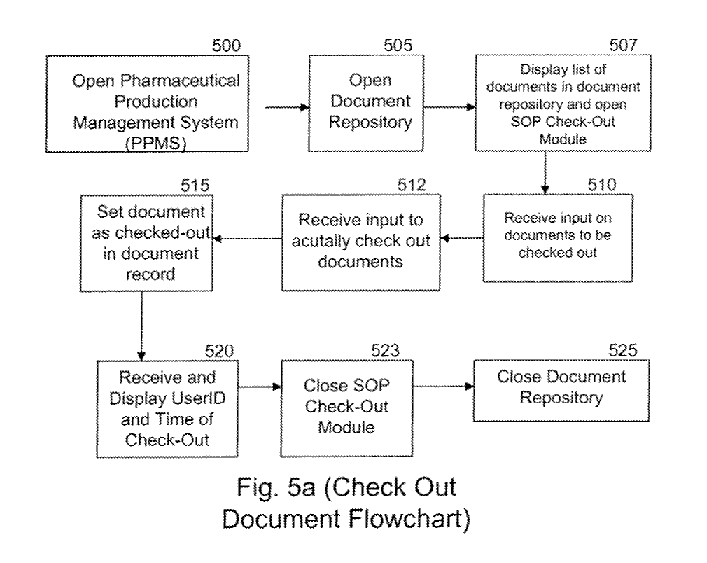

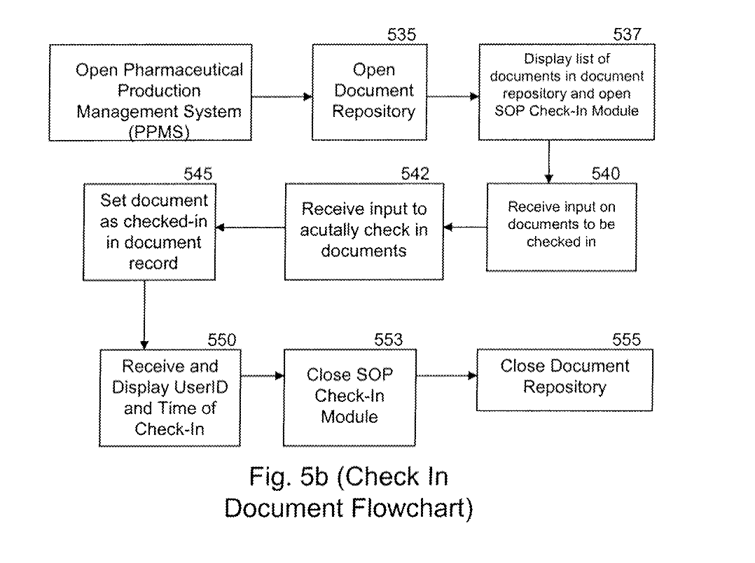

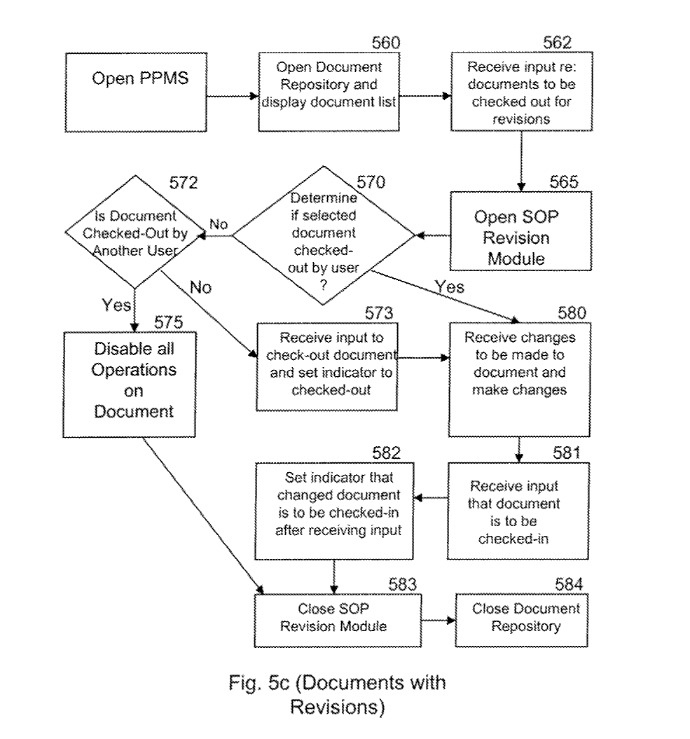

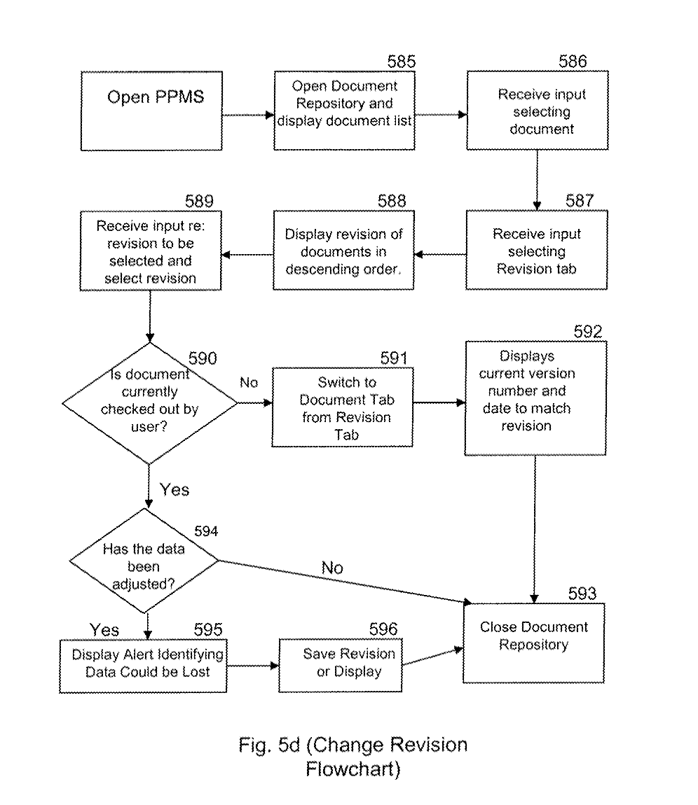

The SOP module also includes functionality to allow checking out and checking in of a document. FIG. 5a illustrates a flowchart of an SOP check-out module according to an embodiment of the invention. After the radiopharmaceutical production management system has been opened 500 and the document repository has been opened 505, a list of available documents may be displayed. The SOP check-out module may also be opened 507. The SOP check-out module may receive 510 document identification input identifying the SOP document to be checked out. Illustratively, a check-out button may be selected 512 on an SOP menu. The SOP check-out module may set an indicator 515 that the selected SOP document is checked out.

The SOP check-out module may also extract or receive a user ID of the individual checking out the document and also the time the document was checked out. The SOP check-out module may record 520 this information in the SOP document record in the document repository. Under certain operating conditions, a menu may indicate that the selected document is checked out (e.g., any menu that displays lists of available or checked-out documents). The SOP check-out module may be closed 523. The document repository may be closed 525. An administrator may also be able to cancel the document check-out by performing the same above actions but instead of selecting that the document be checked out, instead unselecting the document to be checked out 0081. FIG. 5b illustrates a flowchart of an SOP check-in module according to an embodiment of the invention. The Pharmaceutical Production Management System may be opened. The document repository may be opened 535. A list of documents may be displayed from the document repository of documents that are checked out. The SOP Check-In Module may be opened 537. The SOP Check-In module may receive 540 input that documents are to be checked in. The SOP Check-In module may receive actual input to check-in the documents (e.g., via a check-in button). The SOP Check-In module sets 545 that the selected document is checked-in. The SOP Check-In module records and displays 550 the user-ID checking in the document and the time of the check-in. The SOP Check-In module is closed 553. The document repository is closed 555.

The SOP Module includes functionality for making adjustments to SOP documents. FIG. 5c illustrates a flowchart of the SOP Revision module according to an embodiment of the invention. The PPMS is opened. The document repository is opened and a document list is displayed 560. The document repository receives 562 input regarding whether documents are to be checked out for revisions. The SOP Revision module is opened 565. The SOP Revision module determines 570 if selected document is checked out by the user. If the document is checked out by the user, the SOP Revision module receives 580 changes to be made to the document and makes the changes in the document. The SOP Revision module receives 581 input that the document is to be checked-in. The SOP Revision module sets 582 an indicator that the changed document is to be checked-in. The SOP Revision module is closed 583.

The SOP Revision module then determines 572 if the document is checked-out by another user. If the SOP Revision module determines that the document is not checked-out by another user, then the SOP Revision module receives input to check out the document and sets 573 an indicator in the document record to checked-out for the selected. Then steps 580-583 are performed as is described below.

If the SOP Revision Module determines that the document is checked-out by another user, then the SOP Revision module disables 575 all operations on the selected document. The SOP Revision Module is closed 583 and the document repository is closed 584.

The SOP module includes functionality to change revisions. FIG. 5d illustrates a flowchart for revision changing according to an embodiment of the invention. The document repository is opened and a document list is displayed 585. The SOP module receives 586 input selecting a document. The SOP module receives 587 input selecting a Revision tab. The SOP module displays 588 revisions of the document in descending order. The SOP module receives input regarding the revision to be selected and selects 589 the revision. The SOP module determines 590 if the document with the selected revision is currently checked out by the user. If the document is not checked out by the user, the SOP module switches 591 from the revision tab to the document tab. The SOP module displays 592 the current version number and the date to match the revision selected. If the document is currently checked out by the user, the SOP module determines 594 if the data has been adjusted. If the data has not been adjusted, the document repository is closed 593. If the data has been adjusted, then the SOP module displays 595 an alert that data could be lost. Depending on the user's response, the data that has been adjusted is saved 596 or canceled. The document repository is then closed 593.

The SOP module may include a check-in module. If the document repository is opened, documents in the document repository may be checked out 570. For example, a check out button may be selected. The document repository indicates that the document is checked out. If a document needs to be checked in (or the checkout needs to be cancelled), then after the document repository is opened, a document may be selected 575 that has a checked out status. The document may be checked in 580. For example, a user may select a “Cancel Check Out” button.

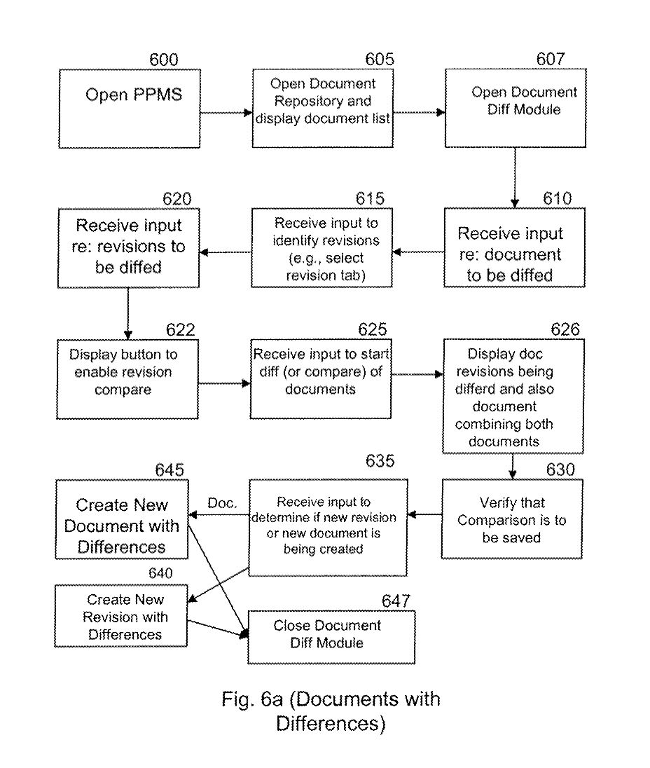

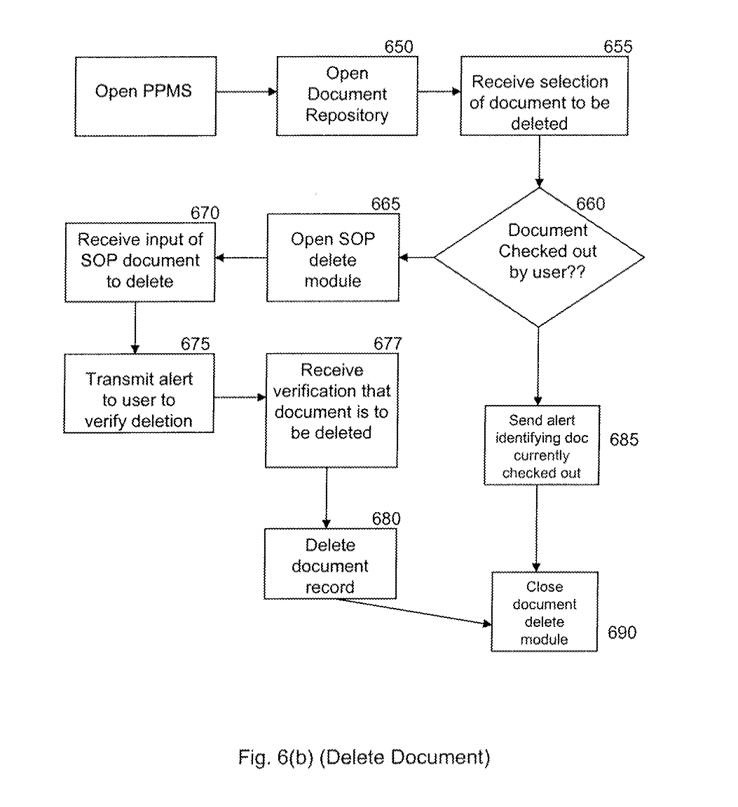

The SOP module may also include functionality to highlight differences between SOPs. FIG. 6 illustrates a flowchart of operation of a Diff Module according to an embodiment of the invention. In the document repository, a document may have different revisions and the document repository monitors the different revisions. The SOP module opens the Document Repository. A diffed document may be selected 605. The SOP module opens 607 a Diff Module. This is the document that will either be used as a base document or there will be a different revision number. The SOP module may present 610 different revisions of the document. For example, a revision tab may be displayed 610. The revision tab may be selected 615 and different revisions or versions of the diffed document may be presented in a revision grid. Different versions of the diffed document may be selected 620. For example, two different revisions of the document displayed in the revision grid may be selected. Once different versions of the diffed document are selected, a diff button is enabled 622. The diff button may be selected 625. Under certain operating conditions, the SOP module displays 626 the two revisions of the documents adjacent to each other. Once the diff (difference button) is selected, the SOP Diff Module compares the documents to each other and combines them. Under certain operating conditions, the SOP Diff module displays 626 a document containing the two revisions of the documents combined. In an embodiment of the invention, the SOP Diff Module displays the two documents next to each other and below the documents is a document containing the 2 documents combined.

The document containing the two revisions of the document may be accepted 630. If the new document is selected and accepted, the SOP diff module receives input identifying if the diffed document is saved 635 as a new revision of the existing document or a new document is created. If the diffed document is saved as a new revision of the original document, a new revision with the differences is created 640. If the diffed document is saved as a new document, then the SOP module saves 645 the document with differences into the Document Repository. After this has been completed, the SOP module closes 647 the SOP diff module.

SOPs or other documents may need to be deleted from the document repository. The SOP module may open 650 the Document Repository. The SOP module presents a list of documents in the Document Repository. A document in the Document Repository may be selected 655 (or the SOP Module may receive input identifying a document to be deleted). The SOP module determines if the selected document for deletion is checked out (has a checked out status). If the selected document includes is checked out, the SOP module identifies 660 that the selected document is checked out and may also display a user that checked out the document and a time of checkout. If the selected document for deletion is not checked-out, the SOP module opens 665 an SOP delete module and presents a delete menu option. For example, the SOP delete module generates a delete button. The SOP delete module may receive 670 a selection of the delete button. The SOP delete module may display 675 an alert to verify that the selected document is deleted. The SOP Module receives verification that the selected document should be deleted, then the SOP Module deletes 680 the document from the Document Repository. If the document was currently checked out by a user the SOP module (or the SOP delete module) may transmit 685 an alert identifying that the document is currently checked out. The SOP module (or SOP delete module) may also identify who the user is that checked out the document and what time the document is checked out. The SOP module then closes 690 the SOP delete module and the SOP module may be exited.

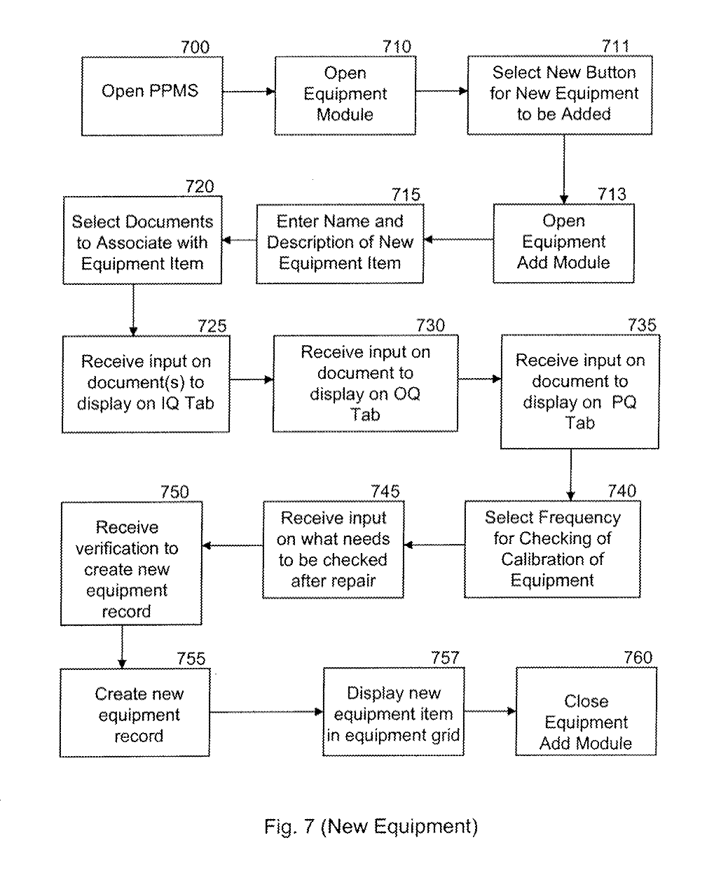

The radiopharmaceutical production management system includes an equipment module. The equipment module includes SOPs for each piece of equipment utilized in a radiopharmaceutical production and/or in the facility where production or manufacturing occurs. The identification and SOPs for the new equipment may be added to the document repository to assist in ensure proper equipment training has occurred prior to production of a radiopharmaceutical. The equipment module includes an add equipment module, an edit equipment module, a delete equipment module and an equipment completion module. FIG. 7 illustrates operation of an equipment add module according to an embodiment of the invention. An equipment module may be opened 710 and an equipment main menu may be displayed. The equipment module may receive input 711 identifying a new equipment item is to be added to the pharmaceutical production management system. Illustratively, an individual may select a new button 711 on an equipment module main menu. The equipment add module may be opened and an equipment add menu 713 may be displayed. The equipment add module may receive 715 name and description input for the equipment that is to be added to the system. Illustratively, an individual may enter the name and description via a dialog box. The equipment add module may receive 720 document association input identifying which documents from the document repository are to be associated with the newly added equipment. Illustratively, the equipment add module may display a list of SOPs to be associated with or linked with the new equipment. For example, there may be 500 equipment-related SOPs in the radiopharmaceutical production management system and 10 of the SOPs may be associated with the new equipment (e.g., a dose calibrator). Illustratively, a user may select the documents after utilizing an SOP field to browse the document repository. The equipment add module may make 720 the associations with the documents in the document repository.

The equipment add module may receive 725 installation qualification association information for the equipment. In other words, the installation qualification association information identifies what documents from the document repository are associated with the installation qualification for the equipment. The equipment add module may receive 730 operation qualification association information for the newly added equipment. The equipment add module may receive 735 production qualification association information for the newly added equipment. The equipment add module may receive 740 calibration frequency information of the newly added equipment. The calibration frequency information may be that the equipment needs to be checked either daily, quarterly, semi-annually or annually. Under certain operating conditions, the equipment module may receive 745 repair information. Illustratively, this information may identify if the equipment item needs to be re-checked after a repair. A user may select a menu item on the equipment add menu to set whether the equipment needs to be rechecked after a repair. The equipment add module then creates 750 a new equipment record for the new piece of equipment that is being added to the radio pharmaceutical production management system. In an embodiment of the invention, the equipment module main menu may include an equipment grid. After the new equipment record has been created, the newly added equipment item may be displayed in the equipment grid. The equipment add module may then be utilized to add an additional piece of equipment. The equipment module may close 760 the equipment add module after the new equipment record is created. In an embodiment of the invention, the equipment record may be stored in a separate database from the document repository. In an embodiment of the invention, the equipment record may be stored in the document repository and associated database.

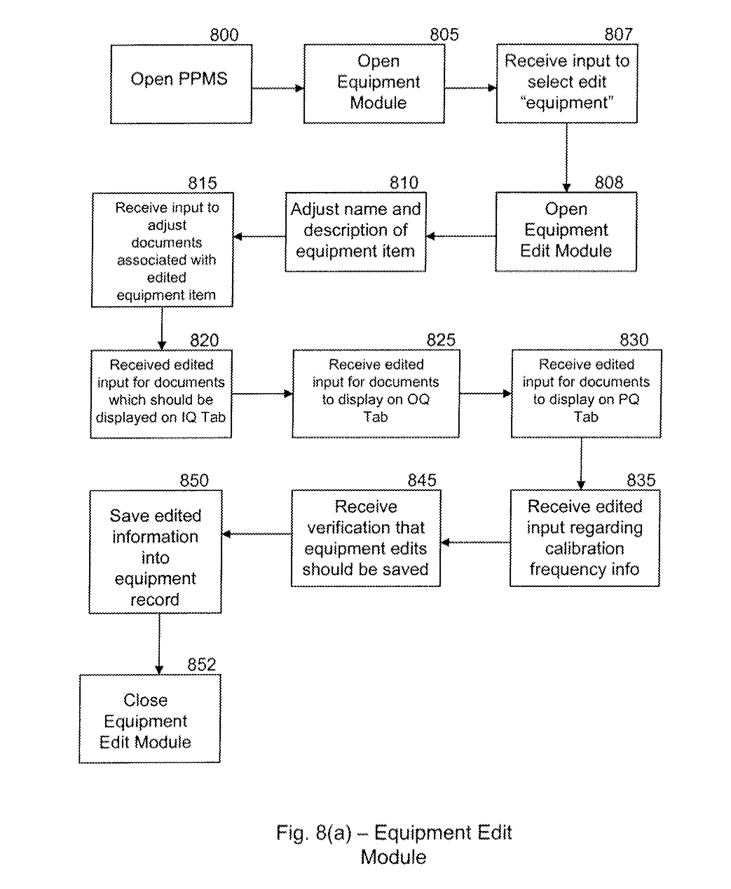

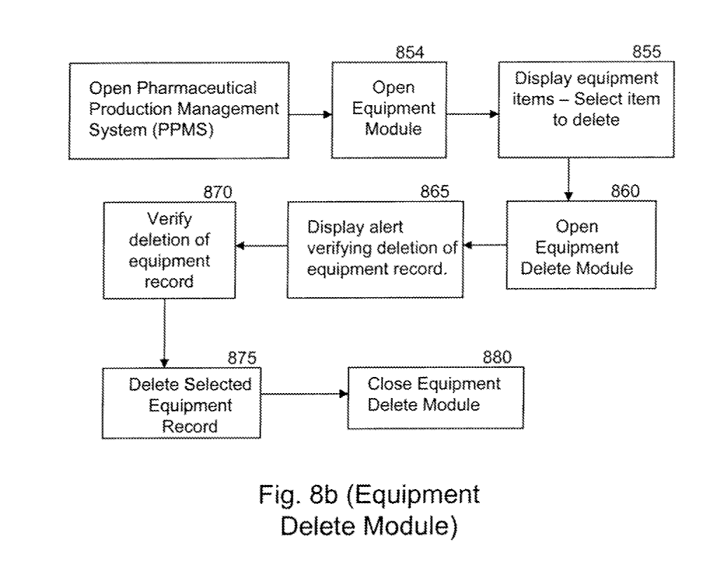

FIG. 8a illustrates an equipment edit module according to an embodiment of the invention. The equipment module may be opened 805. The equipment edit module may receive input identifying that an equipment record needs to be edited 807, e.g., information about an equipment item needs to be modified or changed. For example, an edit button may be selected. The equipment module may open 808 the equipment edit module. The equipment edit module may receive 810 revised or modified name and description information for the equipment item. The equipment edit module may receive input 815 to edit SOP document association information for the equipment item. Illustratively, the user may select different documents or a newly added document from the document repository to associate with the equipment item. In an embodiment of the invention, the equipment edit module may make the edited associations with the documents in the document repository. The equipment edit module may receive 820 input to edit installation qualification association information for the equipment. The equipment edit module may receive 825 input to edit operation qualification association information for the equipment item. The equipment edit module may receive 830 input to edit the production qualification association information for the equipment. The equipment edit module may receive 835 input to edit the calibration frequency information of the equipment item. The equipment edit module may receive verification 845 that the received information is to be saved. The equipment edit module then saves 850 the received information (whether it is edits, modifications, additions or deletions) into the equipment record that was previously created for the equipment item. The equipment module may close 852 the equipment edit module.

FIG. 8b illustrates an equipment delete module according to an embodiment of the invention. The equipment module may be opened 854. The equipment module may receive 855 input identifying that an equipment record needs to be deleted. Illustratively, a user may select a delete button from an equipment module main menu. The equipment module opens 860 the equipment delete module. The equipment delete module may generate 865 a verification alert to verify that the equipment record should be deleted. The equipment delete module may receive 870 verification to confirm deletion of the equipment. After receiving confirmation of deletion, the equipment delete module deletes 875 the equipment record for the selected equipment item. The equipment module then closes 880 the equipment delete module.

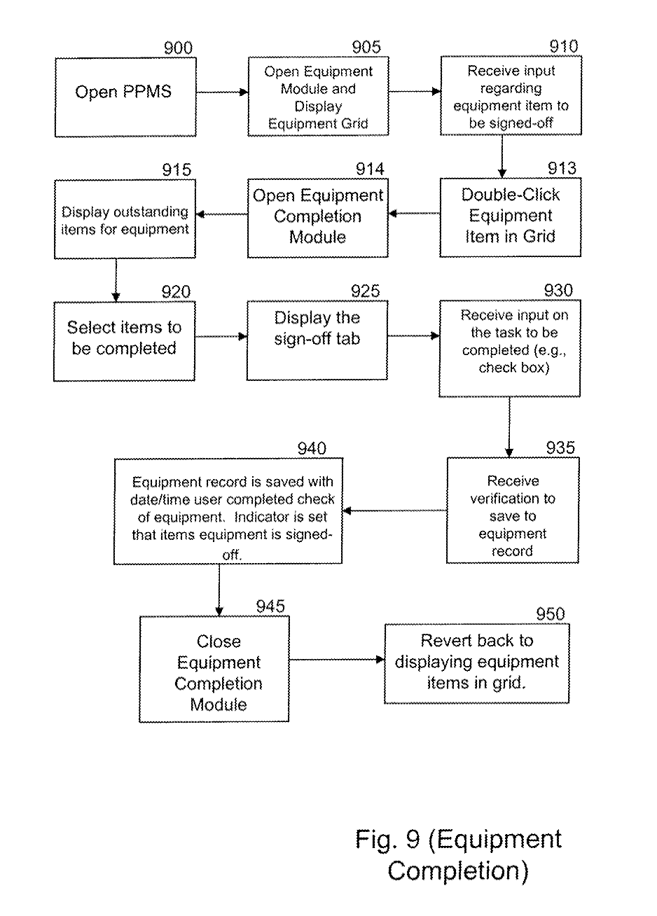

FIG. 9 illustrates an equipment completion module according to an embodiment of the invention. The equipment completion module is utilized to identify if a piece of equipment may be signed off (i.e., completed). The equipment module may be opened 905 and an equipment grid may be displayed. The equipment module may receive 910 equipment identification input 910 identifying equipment to be signed off (or verified). For example, on the equipment module main menu, an equipment grid may be displayed and a piece of the equipment on the equipment grid may be selected 913 (e.g., by double-clicking on the equipment item). The equipment module then opens 914 the equipment completion module. In response to the selection of the equipment, the equipment completion module displays 915 the different tasks needed to be completed for the selected equipment item. Illustratively, the equipment completion module may display that all of the Installation Qualification tasks, the calibration tasks, the Operation Qualification tasks and the Production Qualification tasks needed to be completed for the selected equipment item. Alternatively, the equipment completion module may display that only one of the equipment calibration, installation qualification, operation qualification and production qualification sections needs to be completed for the selected equipment item. The equipment completion module receives input identifying which operation is selected. For example, the equipment completion module receives a selection to work on and complete equipment calibration tasks or for installation qualification tasks. The equipment completion module then displays 915 tasks necessary to pass the selected operation. Illustratively, the equipment completion module displays calibration SOPs for the cyclotron if the cyclotron has been selected as the equipment item. The user or operator then performs the tasks or verifies that the tasks have been completed. The equipment completion module receives 920 input to select a check-off tab and displays 925 the sign-off tab. The equipment completion module receives 930 information that the tasks have been completed. Illustratively, a sign-off tab may be selected and the user may complete a check-box identifying that the tasks have been completed and the operation may be signed off. The equipment completion module receives 930 verification to save the equipment record. The equipment completion module saves 940 the updated completion information to the equipment record for the selected equipment item. If there are additional operations to be performed, the equipment completion module may revert back to the equipment completion screen where a next operation may be selected (Reference number 920). Reference numbers 920-940 are repeated until all of the operations for the selected equipment item have been completed. After all of the operations (and tasks) have been completed for the selected equipment item, the equipment module sets an indicator in the equipment record identifying that the equipment has been signed-off. This is what the production module analyzes or evaluates when it is verifying that pharmaceutical production may continue. The equipment module then closes 945 the equipment completion module unless other equipment items are to be signed-off. If additional equipment needs to be signed off, the equipment module displays the equipment grid and reference number 914-940 may be completed for the additional item. All of the tasks in the equipment completion module do not have to be completed at one time. For example, although the equipment item may need to have equipment calibration tasks completed and production qualification tasks completed, an individual may log into the equipment completion module, complete the equipment calibration tasks, sign off on equipment calibration and exit the system planning to perform the production qualification tasks at a later time.

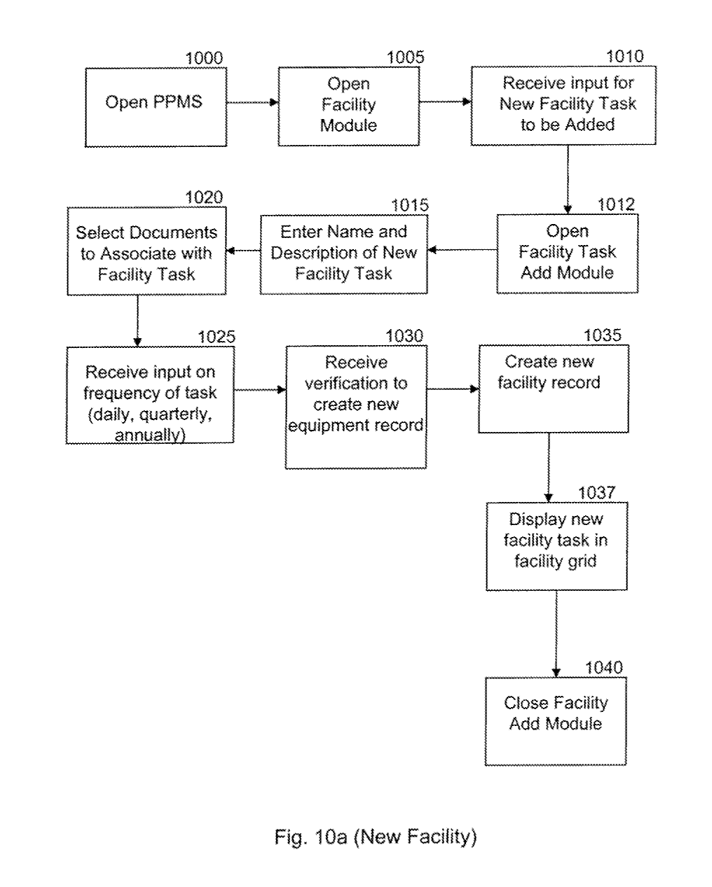

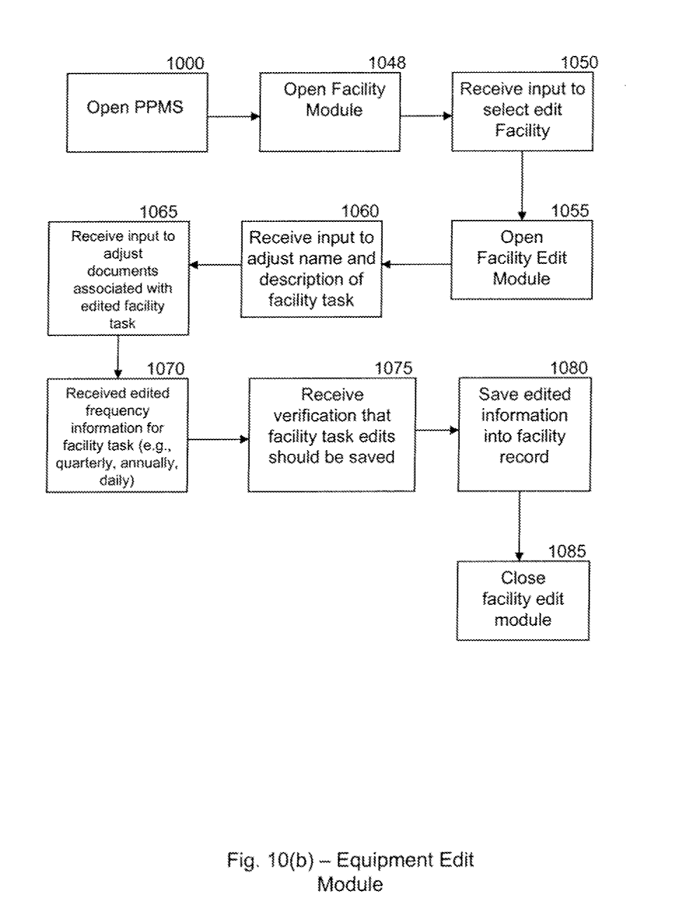

The pharmaceutical production management system includes a facility module. The facility module maintains facility records for facilities that are utilized in the production of radiopharmaceuticals. FIG. 10 illustrates operation of a facility add module according to an embodiment of the invention. A facility record includes facility tasks that are completed. A facility module may be opened 1005. Illustratively, an individual may select a facility toolbar on the production management system main menu. The facility module may receive 1010 input indicating that a new facility task is to be added to a facility record. Illustratively, a user may select a new button on the facility main menu. The facility module may open 1012 the facility task add module. A facility task menu may be displayed. The facility task add module may receive 1015 name and description information for the new facility task. The facility task add module may receive 1020 document association information for documents from the document repository that are to be associated with the new facility task. Illustratively, a user may input into the SOP field names of documents that are to be associated with the new facility task. The user may select these documents via a browse function or a pull-down menu. The facility task add module may receive 1025 input identifying the frequency of performing the new facility task. For example, the frequency of the new task may be daily, quarterly, semi-annually or annually. The facility task add module may receive verification 1030 that a new facility record should be created. After receiving this information, the facility task module may create 1035 a facility record including the new facility task (if there has not been a facility record created). Alternatively, the facility task module save the facility task information (e.g., name/description information, document association information, task frequency information) to an existing facility record (if the facility record already exists)). The facility module may display 1037 contents of the facility record (or facility tasks) in a facility task grid. After the facility task information has been saved, the facility module closes 1040 the facility task module.

The facility module also includes a facility edit module. The facility edit module allows editing of an existing facility task. FIG. 10(b) illustrates a facility edit module according to an embodiment of the invention. The facility module may be opened 1048. The facility module receives 1050 input identifying that a facility task is to be edited. Illustratively, a user selects an edit button on the facility main menu screen. The facility module opens 1055 the facility edit module and a facility task edit screen is displayed. The facility edit modulo may receive 1060 adjusted name and description information to change or modify the name or description of the facility task. The facility edit module may receive 1065 revised document association information, which identifies if new SOP documents are to be associated with the facility task, or if SOP documents are to be disassociated from the facility task. The facility edit module may receive 1070 revised frequency information for the facility task. The facility edit module receives verification 1075 that the edited information should be saved into the facility record. After the facility edit module receives the edited information (e.g., adjusted name and description information, revised document association information, revised frequency information), the facility edit module saves 1080 the edited information into the facility record (and thus the facility task record). After the edited information is saved into the facility record, the facility module closes 1085 the facility edit module.

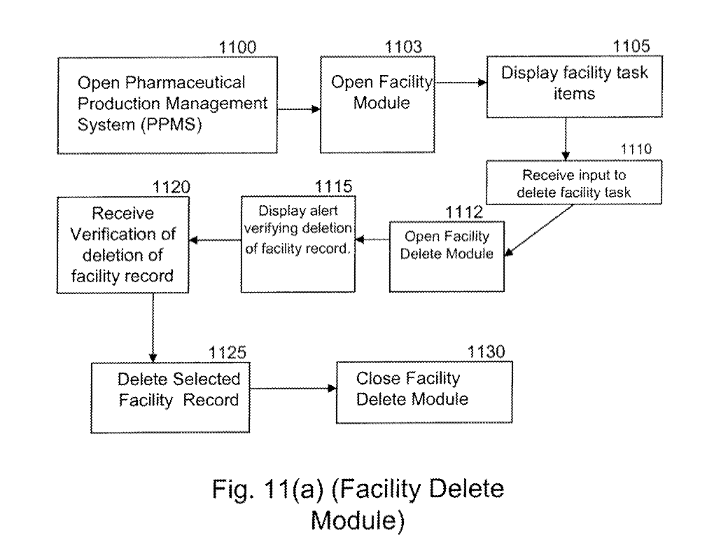

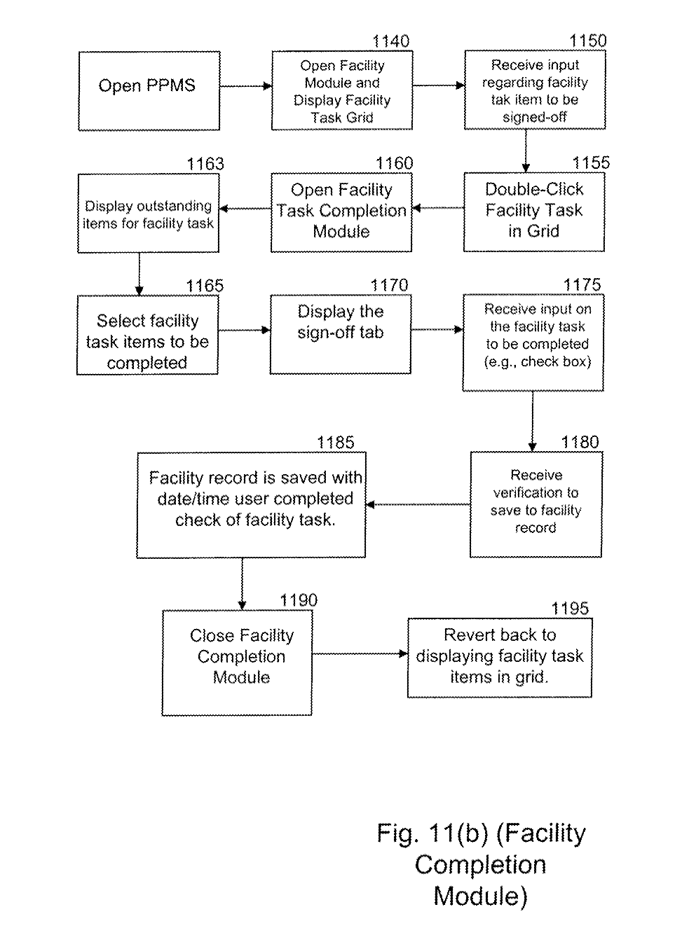

The facility module also includes a facility task delete module. The facility task delete module allows deletion of the existing facility task. FIG. 11(a) illustrates operation of a facility delete module according to an embodiment of the invention. The facility module is opened 1103. The facility module receives 1105 input identifying that a facility task is to be deleted. Illustratively, a user selects 1110 a delete button on the facility main menu screen. The facility module opens 1112 the facility task delete module. The facility task delete module may generate 1115 a verification alert to verify that the facility task record should be deleted. The facility task delete module may receive 1120 verification to confirm deletion of the facility task. After receiving confirmation of deletion, the facility task delete module deletes 1125 the facility task in the facility record for the selected facility. The facility module then closes 1130 the facility task delete module.

The facility module includes a facility task completion module. The facility task completion module allows a user to enter information identifying that specific facility tasks are to be completed. FIG. 11(b) illustrates the operation of the facility task completion module according to an embodiment of the invention. The facility module, when opened and operational 1140, may display a facility task grid. The facility task grid may list all tasks that have been entered and stored in a facility record in the radiopharmaceutical production management system. For example, a facility task grid may include eight tasks that need to be performed at the facility before radiopharmaceutical production may begin. The facility module may receive 1150 selection input identifying which of the facility tasks is selected for completion. Illustratively, a user may select one facility task by double-clicking 1155 on a facility task in the grid. The facility module opens 1160 the facility task completion module and the facility task completion module displays a facility task completion menu. The facility task completion menu may include an operation tab and a sign-off tab. The facility task completion module may display 1163 an operation tab that may be selected. The facility task completion module displays 1165 information on how to complete the selected facility task. The facility task completion module then displays 1170 task sign-off input. Illustratively, a user may select a sign-off tab on the facility task completion menu. The facility task completion module then receives 1175 task completion input identifying that the task has been completed. Illustratively, a user may select or check a Completed menu box on the facility task completion menu. The facility task completion module receives verification 1180 to save the sign-off information for the facility task into the facility record. The facility task completion module saves 1185 this information (i.e., that the task has been completed) to the facility task record. The facility task record may include the date that the user checked the facility to verify that the tasks had been completed. The facility task module may close 1190 the facility task completion module. The facility module may then display 1195 the facility task grid. The facility module may display an indicator next to any facility tasks that have been signed off.

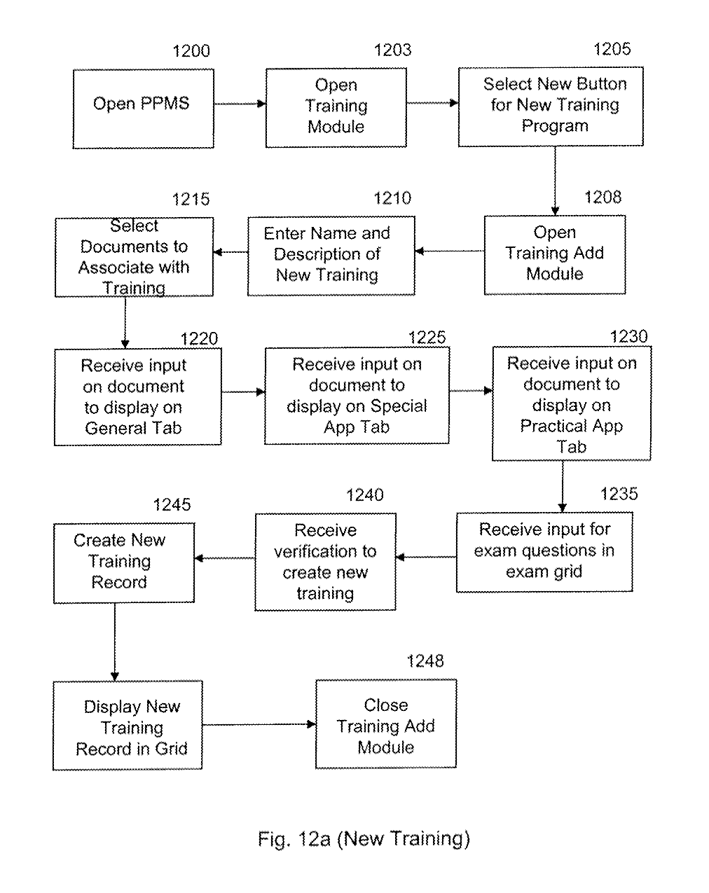

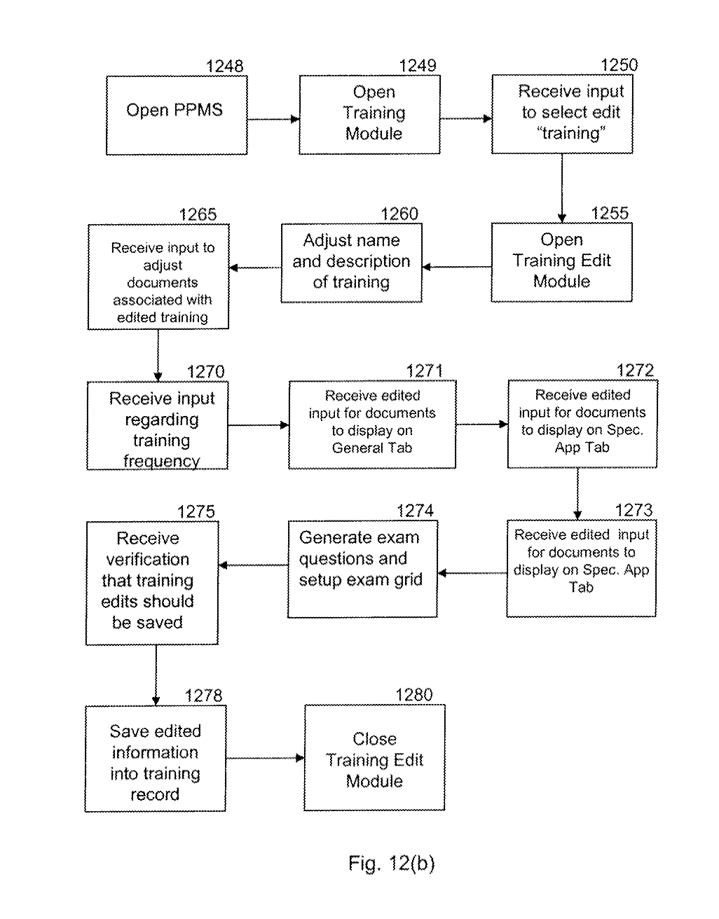

The training module keeps track of training performed by individuals on equipment and also additional training exercises that should be performed on the equipment prior to production of a radiopharmaceutical. FIG. 12 illustrates operation of a training add module according to an embodiment of the invention. The training module is analyzed or examined by the production module to verify that necessary training has been completed. The training module includes a training add module for adding new training courses or training exercises. The training module is opened 1203. The training module receives 1205 input identifying a new training course or training module is to be added. The training module opens 1208 the training add module and a training add menu is displayed. The training add module receives 1210 name and description information for the new training course or training module. The training add module receives 1215 document association information identifying which documents (e.g., SOPs) are to be associated with the new training course or training exercise. Illustratively, a user may select using a browse feature of the document repository or via a drop down menu. The training add module receives 1220 general tab information which is information about which documents from the document repository should be displayed on a general tab in the production module. The training add module receives 1225 special application tab information which is information about which documents should be displayed on the special application tab. The training add module receives 1230 practical application tab information which is information about which documents should be displayed on the practical application tab. The training add module 1235 receives examination questions and stores the examination questions. The examination questions may also be displayed in an examination grid. The training add module receives 1240 verification information that the training record should be saved. The training add module then stores 1245 the training information (e.g., tab information, name and description information, document association information, examination questions) in a new training record.

In an embodiment of the invention, the training record includes an indicator for which piece of equipment the training record has been established, e.g., has a training record been established for the piece of equipment. If no additional training courses or training exercises need to be added, the training module closes 1248 the training add module.

The training module also includes a training edit module. The training edit module allows editing of an existing training course or training. FIG. 12(b) illustrates operation of a training edit module according to an embodiment of the invention. The training module is opened 1249. The facility module receives 1250 input identifying that an existing training record is to be edited. Illustratively, a user selects an edit button on the training main menu screen. The training module opens 1255 the training edit module and a training task edit screen is displayed. The training edit module may receive 1260 adjusted name and description information to change or modify the name or description of the training record. The training edit module may receive 1265 revised document association information, which identifies if new SOP documents are to be associated with the training course or training record, or if the SOP documents are to be disassociated from the training course or exercise. The training edit module may receive 1270 revised frequency information for the training course or exercise. The training edit module may receive 1271 edited general tab information for the training course or exercise. The training edit module may receive 1272 edited special application tab information for the training course or exercise. The training edit module may receive 1273 edited practical application tab for the training course or exercise. Further, the training edit module may receive 1274 edited examination question information for the training course or exercise. After the training edit module receives the edited information (e.g., adjusted name and description information, revised document association information, revised frequency information), the training edit module verifies 1275 that the edited information should be saved. After the training edit module receives verification, the training edit module saves 1278 the edited information into the training record (for the selected training course or training). After the edited information is saved into the training record, the training module closes 1280 the training edit module.

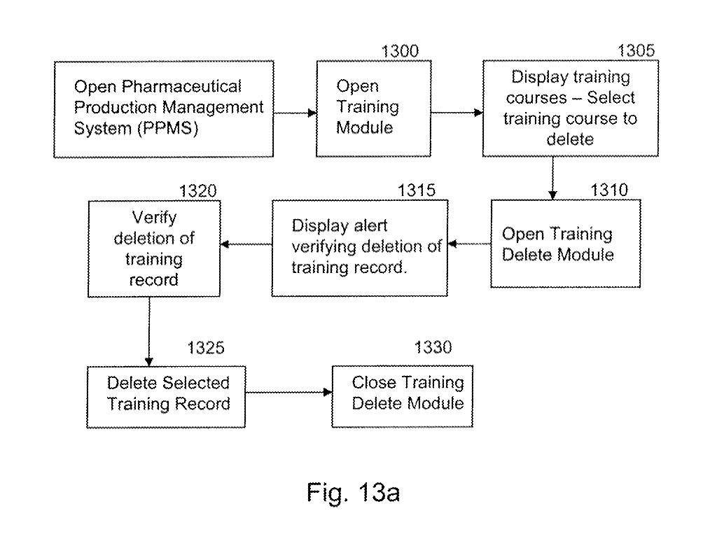

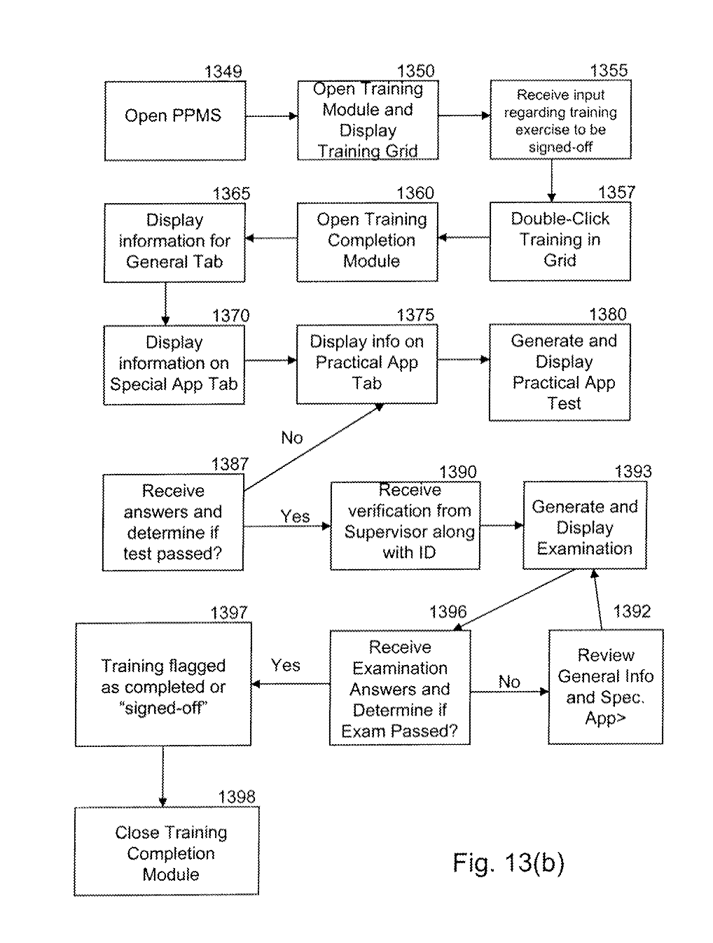

The training module also includes a training record delete module. The training record delete module allows deletion of an existing training record. FIG. 13a illustrates operation of a training delete module according to an embodiment of the invention. The training module is opened 1300. The training module displays training courses and receives 1305 training record deletion input identifying that a training record is to be deleted. Illustratively, a user may select a delete button on the training main menu screen. The training module opens 1310 the training delete module. The training delete module may generate 1315 a verification alert to verify that the training record should be deleted. The training delete module may receive 1320 verification to confirm deletion of the training record. After receiving confirmation of deletion, the training delete module deletes 1325 the training record for the selected training course or exercise. The training module then closes 1330 the facility task delete module.

The training module includes a training completion module. The training completion module allows a user to enter information identifying that specific training courses or exercises have been completed. FIG. 13(b) illustrates operation of a training completion module according to an embodiment of the invention. The training module, when opened and operational, may display 1350 a training course and exercise grid. The training course and exercise grid may list all training courses and exercises that have been entered and stored in training records in the radiopharmaceutical production management system. For example, the training course and exercise grid may include eight training courses and exercises that need to be performed before the radiopharmaceutical production of a selected radiopharmaceutical may begin. The training module may receive 1355 course selection input identifying which of the training courses or exercises is selected for completion (or sign-off). Illustratively, a user may select one training course or exercise by double-clicking 1357 on the training course or exercise in the training course/exercise grid. The training module opens 1360 the training completion module and the training completion module displays a training completion menu. The training completion menu may include a general information tab, a special applications tab, a practical applications tab and a sign-off tab. The training completion module may receive a selection indicating contents of a general tab are to be displayed. The training completion module displays 1365 general information on how to pass the selected training course or training exercise. The training completion module then receives input indicating that a special applications tab has been selected.

The training completion module may display 1370 information related to a special application. The training completion may also play a video or sound file as part of the information that is related to the special application. The training completion module then receives input identifying that a practical application tab has been selected. The training completion module displays 1375 information related to the practical application or may play a multi-media file related to the practical application. The training completion module displays 1380 a practical application test. The user may take the practical application test. The practical application test may be an interactive test, or an online-test provided by a web server. The training completion module receives practical test answers from the user and determines 1387 if the test has been passed. If the training completion module determines the practical application test has not been passed, the training completion module reverts back to displaying practical information on the training course or training exercise (1375). If the training completion module determines the practical application test has been passed, then the training completion module receives 1390 practical test sign-off input identifying that the practical application test has been passed. Illustratively, a supervisor can check the practical application test and sign-off on the passage of the practical application test by inputting his user id and login. The training completion module receives input identifying that an exam tab has been selected. The training completion module displays 1393 an examination based on the training course or training exercise. The training completion module receives 1395 training exam answers and determines 1396 if the training examination has been passed for the selected training course or exercise. If the training examination is not passed, the training completion module may revert back to displaying information from the general information tab or the special application tab. If the training examination was passed, the training completion module sets 1397 an indicator for the training course that the training course or training exercise has been passed. This information may be stored in the training record corresponding to the training course or training exercise. If there are not more training courses or exercises to complete, the training module may close 1398 the training completion module and revert back to displaying the training courses and training exercises in the training grid.

The pharmaceutical production management system includes functionality to allow users to be added to the system, deleted from the system and assigned to specific groups. Before an individual can utilize the pharmaceutical production management system, they have to be established as an authorized user. The administrative module includes an user add module, a user delete module, a user edit module, a user group assign module, and a user group edit module.

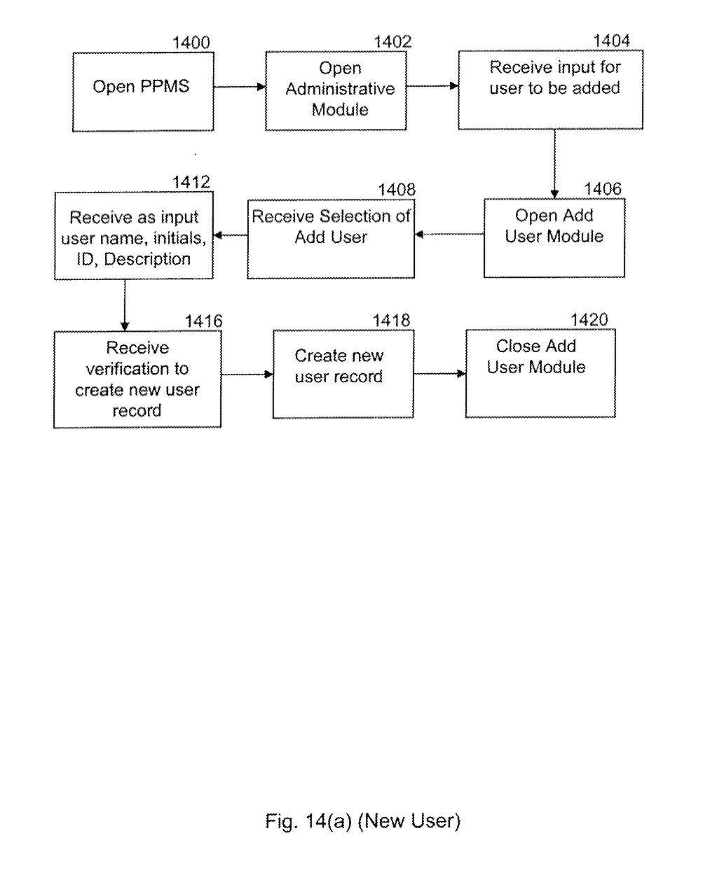

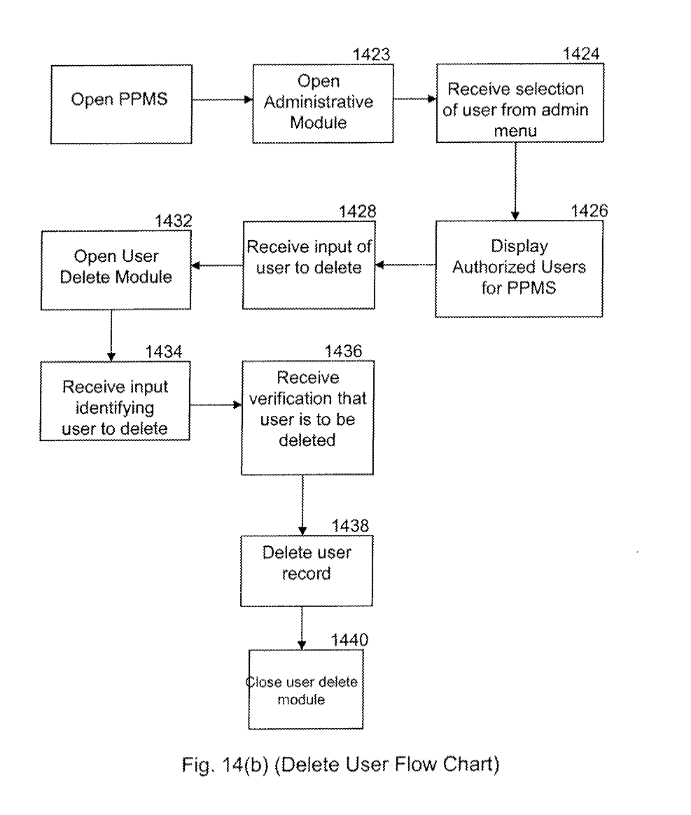

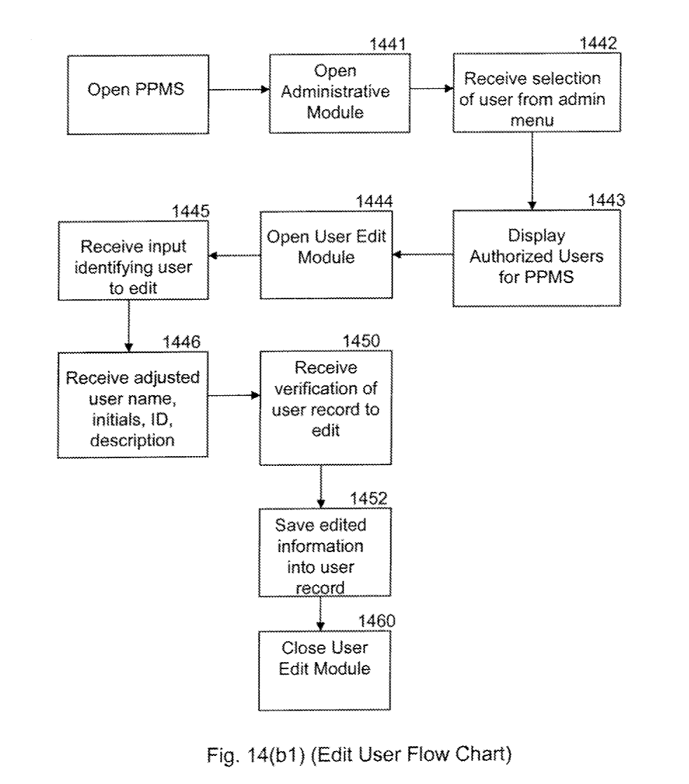

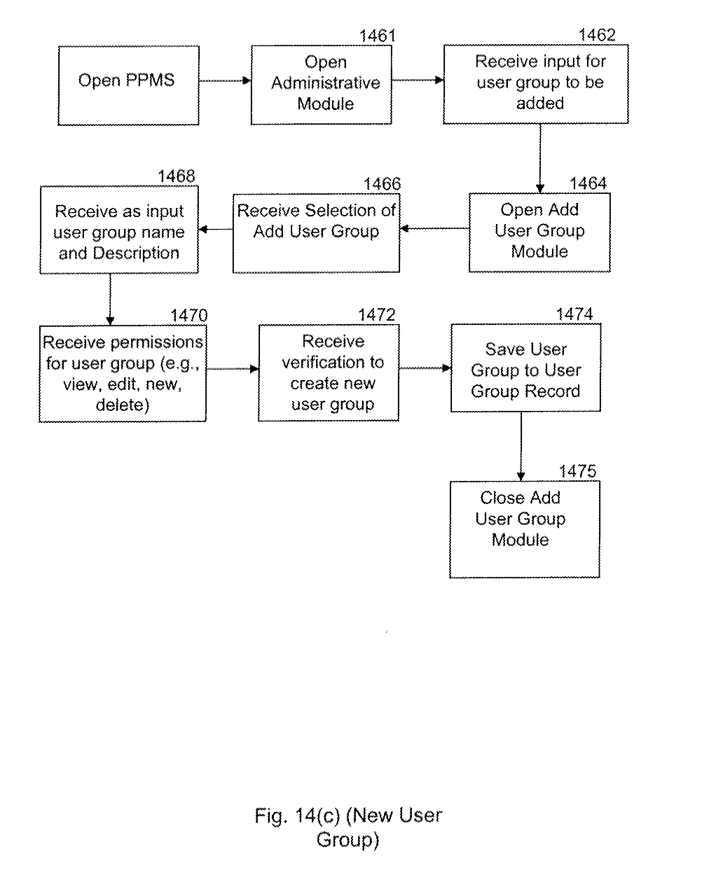

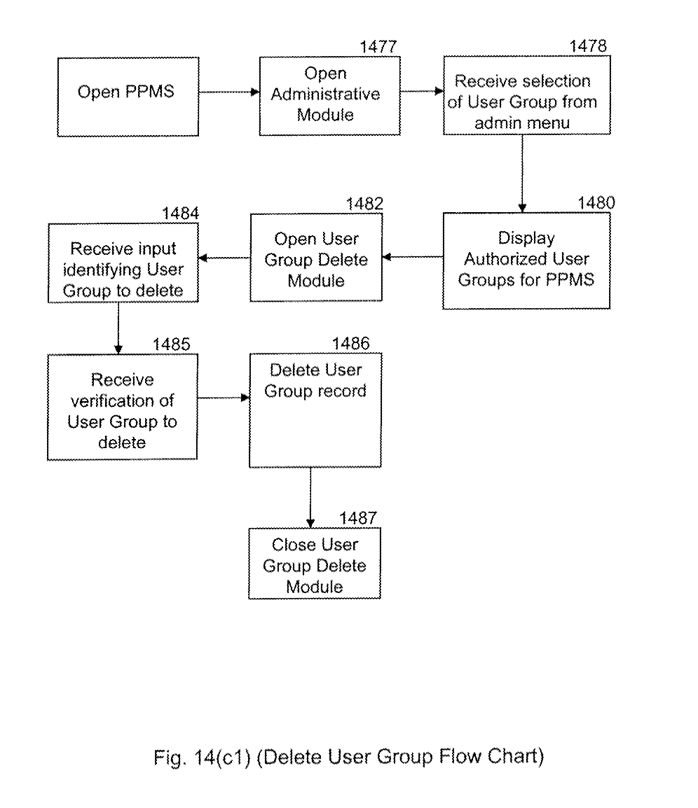

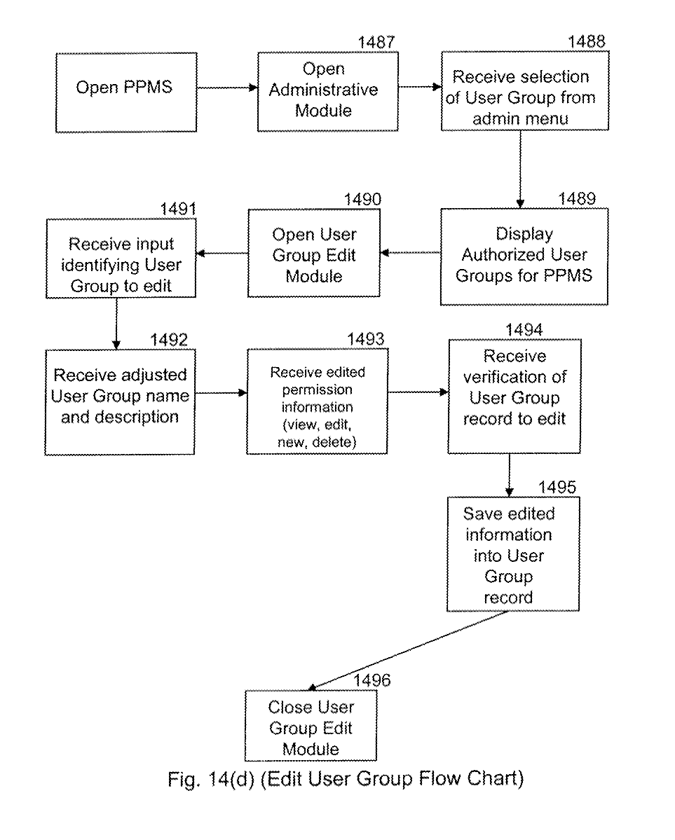

FIG. 14(a) illustrates operation of a user add module according to an embodiment of the invention. The pharmaceutical production management system may be opened 1400. The administrative module may be opened 1402. If a user is to be added as authorized to utilize the pharmaceutical production management system, the administrative module may receive 1404 input identifying that a new user is to be added to the system. Illustratively, the administrative module may display an administrative menu and an administrator may select a user button from the administrative menu. The pharmaceutical production management system may display a user menu and the administrator may select an add button from the user menu. The administrative module may open 1406 a user add module. The user add module may receive 1409 the selection of the add user. The user add module may receive 1412 name and description information for the user to be added. Illustrative name and description information may include a user name, initials, ID and description of the user. The user add module may receive 1416 verification to create a new user record. The user add module saves 1418 the new user information into a user record and a new user record is created. After the user information has been saved, if there are no more users to be added, the administrator module may close 1420 the user add module.

FIG. 14(b) illustrates operation of a user delete module according to an embodiment of the invention. The administrative module may be opened 1423. The administrative module may also receive 1424 input identifying that a user is to be deleted from the system. The administrative module may present 1426 a list of users that have been authorized by the system. The administrative module may receive 1428 input identifying which user is to be deleted from the pharmaceutical production management system. The administrative module may open 1432 a user delete module. Illustratively, the user delete module may display a delete user button. The user delete module may receive 1434 user delete information. The user delete module may transmit a message asking the user to confirm that the specific user should be deleted. The user delete module may receive 1436 confirmation that the specific user should be deleted from the production system. The user delete module then deletes 1438 the user record from the pharmaceutical production management system. The administrative module then deletes 1440 the user delete module.

The administrative module includes an user edit module. FIG. 14b1 illustrates operation of a user edit module according to an embodiment of the invention. The user edit module allows editing of user information in the user record. The administrative module may be opened 1441. The administrative module may display 1443 a list of users authorized in the system. The administrative module may receive 1442 editing information identifying a user that needs to have its user information edited in the user record. The administrative module may open 1444 a user edit module and receives 1445 input identifying which user record to edit. The user edit module may receive 1446 edited information including, but not limited to, a user name, user initials, identification and description information, educational background information. In an embodiment of the invention, training information may be entered into the user record. In a different embodiment of the invention, training information may be in a different record from the user record. The user edit module requests verification that all of the edited information should be saved. The user edit module receives 1450 verification that the edited user information should be saved and saves 1452 the edited information into the user record. The administrative module may close 1460 the user edit module.

The administrative module may also include a user group add module. FIG. 14(c) illustrates operation of a user group add module according to an embodiment of the invention. The administrative module may receive 1462 input identifying that a new user group is to be added to the system. Illustratively, the administrative module may display an administrative menu and an administrator may select a user group button from the administrative menu. The administrative module may then open 1464 the user group add module. Illustratively, a user may select 1466 an add button from the user group menu. The user group add module may receive 1468 group name information. The user group add module may also receive 1470 permission information. Illustratively, this information may include whether a user group are able to perform certain functions (e.g., viewing documents, editing documents, creating documents or deleting documents). After receipt of the name information and the permission information, the user group add module may request 1472 verification of that the new user group should be created. If the user group add module receives verification, the user group add module may save 1474 the new user group and create a user group record. In an embodiment of the invention, the user group record may be associated with the user record. If there are no more user groups to create, the administrative module may close 1475 the user group add module.

The administrative module may also include a user group delete module. FIG. 14(c1) illustrates operation of the user group delete module according to an embodiment of the invention. The administrative module may be opened 1477. The administrative module may receive 1478 input identifying that a user group function has been requested. Illustratively, the administrative module may display an administrative menu and an administrator may select a user group button from the administrative menu. The administrative module may display 1480 authorized user groups for the PPMS. The administrative module may then open 1482 the user group delete module. The user group delete module may receive 1484 deletion information regarding a user group to be deleted. Illustratively, a user may select a delete button from the user group menu and the user group delete module may receive this information. The user group delete module may request 1485 verification information that the user group is to be deleted. If the verification is received, the user group delete module deletes 1486 the identified user group information. If there are no more user groups to delete, the administrative module may close 1487 the user group delete module.

The administrative module may also include a user group edit module. FIG. 14(d) illustrates operation of a user group edit module according to an embodiment of the invention. The administrative module may be opened 1487. The administrative module may receive 1488 input identifying that a user group function has been requested. Illustratively, the administrative module may display an administrative menu and an administrator may select a user group button from the administrative menu. A user group menu may be displayed 1489 along with a group of authorized user groups. The user group module may open 1490 the user group edit module. The user group edit module may receive 1491 identification of a user group to edit. The user group edit module may receive 1492 revised group name information. The user group edit module may receive 1493 modified permission information (e.g., view, edit, new, delete). After receiving the modified user group information, the user group edit module may request 1494 verification that the user group is to be modified. If the verification is received 1494, the user group edit module may save 1495 the modified user group information The administrative module may then close 1496 the user group edit module.

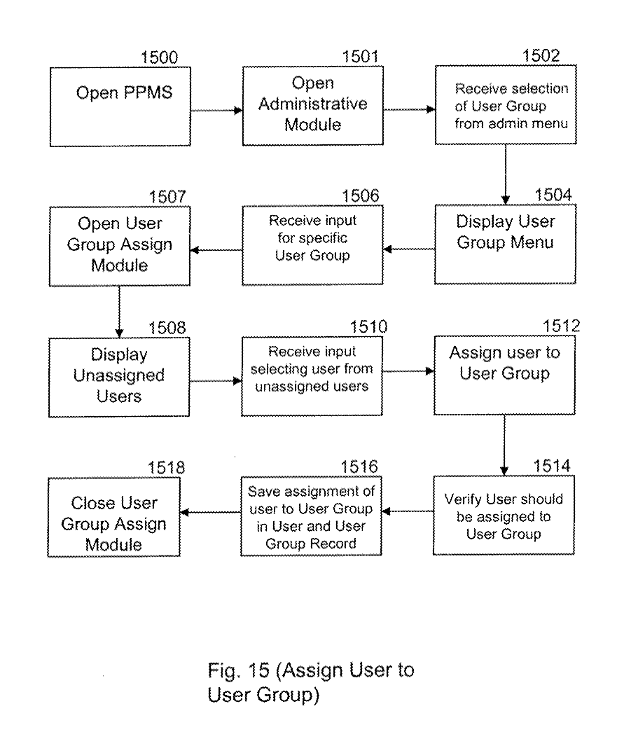

The administrative module may also include a user group assignment module. FIG. 15 illustrates operation of a user group assignment module according to an embodiment of the invention. The administrative module may receive 1502 user group selection information. Illustratively, a user may select a user group option (or button) from an administrative menu. The administrative module may display 1504 a user group menu. The administrative module may receive 1506 user group selection information. The administrative module may open 1507 a user group assignment module. The administrative module or the user group assign module may also display 1508 unassigned users. The user group assignment module may receive 1510 assignment information that an unassigned user is to be assigned to a user group menu. Illustratively, a user may select an unassigned user that is displayed. The user group assignment module assigns 1512 the user to the user group. The user group assignment module may request 1514 verification information that the user should be assigned to the user group. The user group assignment module 1516 may save the user group assignment information for the user. Illustratively, the user group record is updated along with the user record. If there are no more users to be assigned, the administrative module may close 1518 the user group edit module.

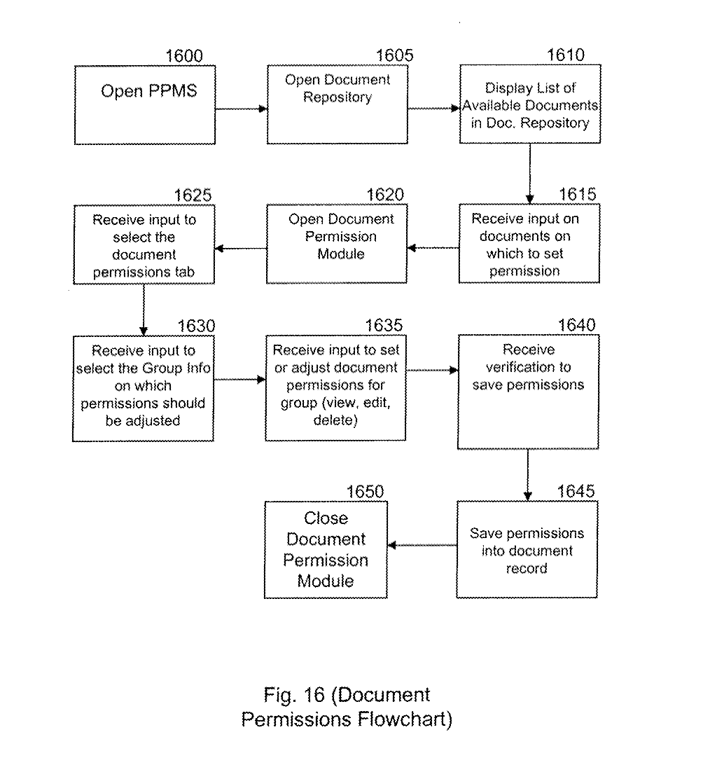

The radiopharmaceutical production management system includes a document permission module. The document permission module interfaces with the document repository. FIG. 16 illustrates operation of the document permission module according to an embodiment of the invention. The radiopharmaceutical production management system may be opened 1600. The document repository may be opened 1605. The document repository module may display 1610 a list of documents residing in the document repository. The document repository module may receive 1615 document selection input identifying which document may have permissions set or established. The document repository module may open 1620 a document permission module. The document permission module may receive input 1625 identifying that permissions are to be set for the selected document. For example, a user may select a permissions tab. The permissions module may display 1630 permissions available for the selected document. Illustratively, document permissions may include view, edit or delete. The permissions module receives 1635 permissions input identifying which permission are to be set for the selected document. The permissions module requests 1640 verification that the permission are to be saved. The permissions module receives verification that the permissions are to be saved for the selected document and interacts with the document repository module to save 1645 the permission information in the document record located within the document repository. The document repository module closes 1650 the permissions module if there are no more documents which need permissions set.

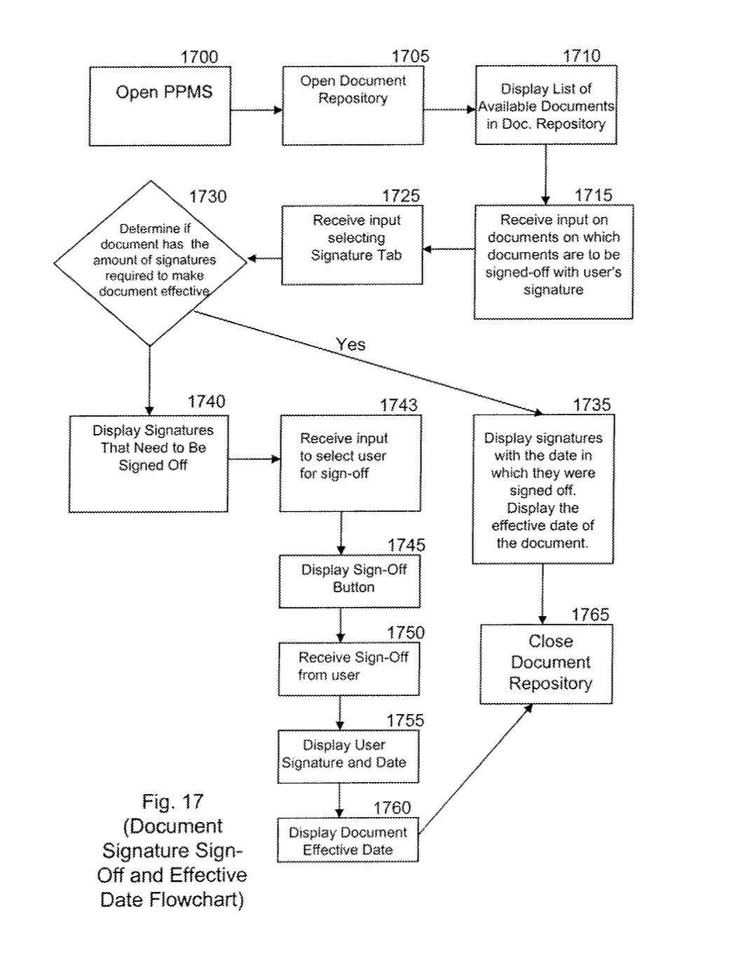

The radiopharmaceutical production management system includes a document sign-off module. The document sign-off module interfaces with the document repository. FIG. 17 illustrates operation of the document sign-off module according to an embodiment of the invention. The document repository may be opened 1705. The document repository module may display 1710 a list of documents residing in the document repository. The document repository module may receive 1715 document selection input identifying which document is to be signed off. The document repository module may open 1720 a document sign-off module. The document sign-off module may receive input 1725 identifying that signatures are going to be signed-off for the selected document. For example, a user may select a signature tab.

The document sign-off module then reviews the document record for the selected document and determines 1730 if all of the signatures required to make the document effective have been received. If the selected document already has the required signatures, the document sign-off module displays the signatures (or signature names) and the sign-off date. In addition, the document sign-off module may display 1735 when the selected document is to become effective.

If the document sign-off module determines that all of the required signatures have not been received, the document sign-off module displays 1740 users that have not signed off on the document. The document sign-off module then displays 1745 an indicator that can be utilized to sign-off the selected document. For example, the document sign-off module may display a sign-off button. The document sign-off module requests 1750 that the user sign-off on the selected document. The document sign-off module receives 1755 sign-off information and then displays a user's signature and sign-off date. If more user's signatures are required, then the document sign-off module returns to step 1740 and repeats the process. If no more signatures are required for the selected document, the document sign-off module sets and displays 1760 the Effective date information for the selected document. The document repository module then closes 1765 the document sign-off module.

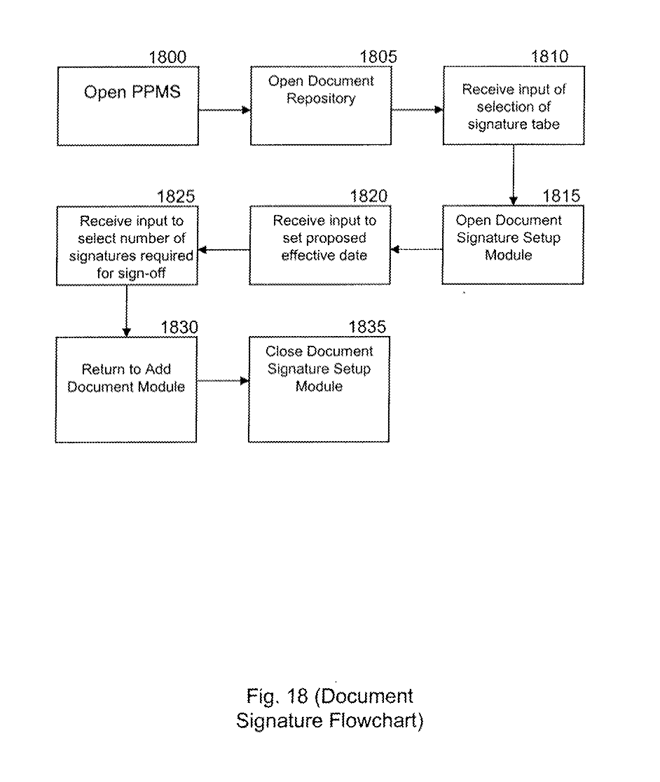

The radiopharmaceutical production management system includes a document signature setup module. The document signature setup module interfaces with the document repository. FIG. 18 illustrates operation of the document signature setup module according to an embodiment of the invention. The radiopharmaceutical production management system may be opened 1800. The document repository may be opened 1805. After a document has been created (or is being created) by the document add module, input may be received 1810 identifying that signature requirements need to be established. Illustratively, a user may select a signature tab. The document repository module may open 1815 a document signature setup module. The document signature setup module receives 1820 a proposed Effective date for the created document. The document signature setup module may receive 1825 a number of signatures required to make the document effective. In addition, certain levels of signatures (i.e., different management level signatures or department signatures) may also be received. The document signature setup module may transfer 1830 the setup information (e.g., proposed Effective date and number of signatures) to the document add module. The document repository module may close 1835 the document signature setup module.

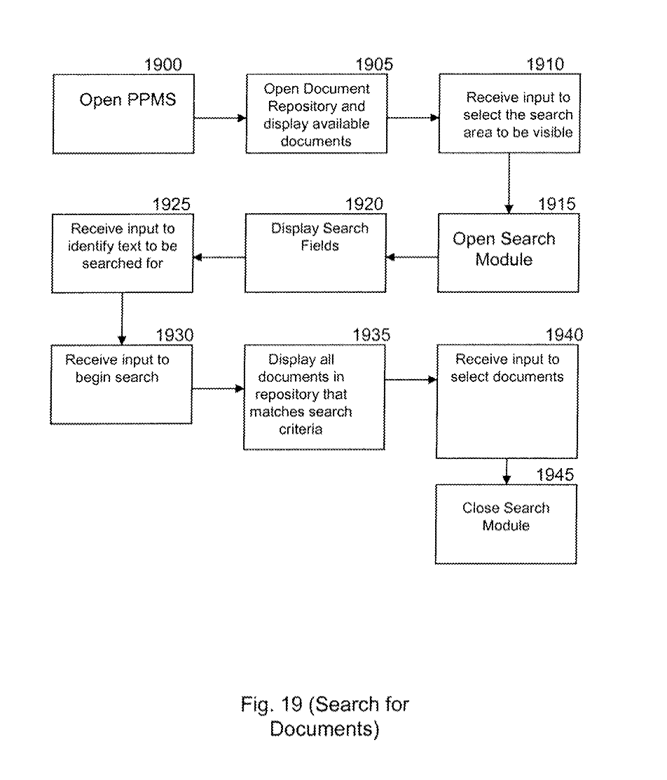

The radiopharmaceutical production management module may include a search module. The search module interfaces with the document repository and the document repository module. FIG. 19 illustrates operations of the search module according to an embodiment of the invention. The radiopharmaceutical production module may be opened 1900. The document repository module and the document repository may be opened 1905. A document repository module may receive 1910 a search request. For example, a user may select a search area on a document repository menu to be visible. The document repository module may open 1915 a search module. The search module may display 1920 fields available for searching. The search module may receive 1925 search term and search field input identifying which search fields are to be searched along with the search terms. The search module may initiate the search 1930. Illustratively, the search module may receive a user's selection of the search button. The search module may generate and then display 1935 a document tree that lists all documents in the document repository that met the search terms. The user may then select a document or rerun a search. The search module may then receive input to either select 1940 a document or rerun the search. The document repository module may then close 1945 the search module.

A number of embodiments of the invention have been described. Nevertheless, it will be understood that various modifications may be made without departing from the spirit and scope of the invention. For example, some of the steps described above may be order independent, and thus can be performed in an order different from that described. Accordingly, other embodiments are within the scope of the following claims.

1. A computer-implemented method, utilizing a computer comprising a memory, a storage device and a processor, the storage device having instructions stored therein, the instructions, which when loaded into memory and executed by the processor, causes the computer to:
receive, at a production module on the computer, login information corresponding to a user;
receive, at the production module, a request for production of a radioactive pharmaceutical;
verify, utilizing a training module on the computer, completion by the user of at least a training program corresponding to production of the radioactive pharmaceutical;
verify, utilizing an equipment module on the computer, completion by the user of equipment calibration requirements and equipment qualification requirements for the equipment that is used in the production of the radioactive pharmaceutical; and
prevent access, by the production module, to further operations of the production module if the training program has not been completed, the equipment calibration requirements have not been completed or the equipment qualification requirements have not been completed,
wherein the production module is utilized to manage production activities associated with radioactive pharmaceutical.

2. The computer-implemented method of claim 1, including instructions, which when executed by the processor, causes the computer to:
verify, utilizing the training module on the computer, completion of a training simulation corresponding to the production of the radioactive pharmaceutical and
prevent access, by the production module, to further operations of the production module if the training simulation had not been completed.

3. The computer-implemented method of claim 1, including instructions, which when executed by the processor, causes the computer to:
transmit a message to a display device coupled to the computer indicating which one of the equipment requirements had not been completed.

4. The computer-implemented method of claim 1, including instructions, which when executed by the processor, causes the computer to:
transmit a message to a display device coupled to the computer that the training program had not been completed.

5. The computer-implemented method of claim 1, including instructions, which when executed by the processor, causes the computer to:
before verifying the training program has been completed, display a practical test corresponding to the training program on a display device coupled to the computer;
receive test answer information along with user login information for the practical test; and
confirm passing of the practical test corresponding to the training program.

6. The computer-implemented method of claim 5, including instructions, which when executed by the processor, causes the computer to:
before verifying the training program has been completed, display an examination corresponding to the training program on a display device coupled to the computer;
receive exam answer information along with user login information for the examination;
confirm passing of the examination corresponding to the training program; and
setting an indicator in a training record associated with the production of the radioactive pharmaceutical to identify the training program has been signed-off.

7. The computer-implemented method of claim 1, including instructions, which when executed by the processor, causes the computer to:
before verifying the equipment calibration has been completed, display a list of calibration requirements for the equipment associated with the production of the radioactive pharmaceutical;
receive verification that the calibration requirements for the equipment have been completed; and
setting an indicator in the training record associated with the production of the radioactive pharmaceutical to identify the calibration requirements have been completed.

8. The computer-implemented method of claim 1, including instructions, which when executed by the processor, causes the computer to:
before verifying the qualification requirements for the equipment have been completed, display a list of qualifications requirements for the equipment associated with the production of the radioactive pharmaceutical;
receive verification that the qualifications requirements for the equipment have been completed; and
setting an indicator in the training record associated with the production of the radioactive pharmaceuticals to identify the qualifications requirements for the equipment have been completed.

9. A computer-implemented method, a computer comprising a memory, a storage device and a processor, the storage device having instructions stored therein, the instructions, which when loaded into memory and executed by the processor, causes the computer to:
receive, at a production module on the computer, login credentials corresponding to a user;
receive, at the production module, a request for production of a radioactive pharmaceutical;
verify, utilizing a training module on the computer, completion of a training program by the user, the training modules corresponding to production of the radioactive pharmaceutical;
verify, utilizing an equipment module on the computer, completion of equipment calibration for equipment that is used in the production of the radioactive pharmaceutical;
verify, utilizing a facility module on the computer, completion of facility tasks for a facility in which the production of the radioactive pharmaceutical is performed; and
prevent access, by the production module, to further operations of the production module if the training program has not been completed, the calibration requirements of the equipment has not been completed, and the facility tasks have not been completed, wherein the production module is utilized to manage and track production activities associated with the radioactive pharmaceutical.

10. The computer-implemented method of claim 9, including instructions, which when executed by the processor, causes the computer to:
verify, utilizing an equipment module on the computer, completion of qualification requirements for equipment that is used in the production of the radioactive pharmaceutical; and
prevent access, by the production module, to further operations of the production module if the qualification requirements have not been completed for the equipment.

11. The computer-implemented method of claim 9, including instructions, which when executed by the processor, causes the computer to:
verify, utilizing the training module on the computer, completion of a training simulation corresponding to the production of the radioactive pharmaceutical and
prevent access, by the production module, to further operations of the production module if the training simulation had not been completed.

12. The computer-implemented method of claim 9, including instructions, which when executed by the processor, causes the computer to:
before verifying the facility task has been completed, display information corresponding to the facility on a display device coupled to the computer;
receive confirmation of completion of the facility task; and
update a facility record to identify that the facility task has been completed.

13. The computer-implemented method of claim 9, including instructions, which when executed by the processor, causes the computer to:
transmit a message to a display device coupled to the computer indicating which one of the equipment requirements had not been completed.

14. The computer-implemented method of claim 9, including instructions, which when executed by the processor, causes the computer to:
transmit a message to a display device coupled to the computer that the training program had not been completed.

15. The computer-implemented method of claim 9, including instructions, which when executed by the processor, cause the computer to:
transmit a message to the display device coupled to the computer that the facility task has not been completed.
